(19) United States
(12) Patent Application Publication
(10) Pub. No.: US 2015/0381689 A1
(43) Pub. Date: Dec. 31, 2015

(54) Methods, Systems and Devices for Spoiler Alert and Prevention Using Networking Framework

(71) Applicant: QUALCOMM Incorporated, San Diego, CA (US)

(72) Inventors: Shriram Ganesh, San Diego, CA (US); Rexford Hill, San Diego, CA (US); Babak Forutanpour, Carlsbad, CA (US); Jose Roberto Menendez, Encinitas, CA (US)

(21) Appl. No.: 14/679,534

(22) Filed: Apr. 6, 2015

Related U.S. Application Data
(60) Provisional application No. 62/017,882, filed on Jun. 27, 2014.

(51) Int. Cl. H04L 29/06; G06Q 30/02

(52) U.S. Cl. CPC H04L 65/604; G06Q 30/0261; G06Q 30/0267

(57) ABSTRACT

Methods, systems and devices are provided for blocking spoiler content from being presented by a content presenting device to a user of a mobile computing device. The content presenting device and the mobile computing device may communicate using a networking framework. One or more spoiler alert events received by the content presenting device via the communication networking framework from the mobile computing device include information associated with content that has not been viewed by a user of the mobile computing device. The information associated with the content that has not been viewed is compared with the content to be presented. It may be determined whether the content to be presented by the content presenting device includes the spoiler content, and, if so, the presentation of the spoiler content by the content presenting device is restricted.

### CROSS-REFERENCE TO RELATED APPLICATIONS

This application claims the benefit of priority to U.S. Provisional Patent Application No. 62/017,882, entitled “Methods, Systems and Devices for Spoiler Alert and Prevention Using Networking Framework,” filed on Jun. 27, 2014, the entire contents of which are incorporated herein by reference.

### BACKGROUND

As technological capabilities have evolved and users have become more sophisticated and mobile, the culture of stationary, fixed presentation schedule media consumption is rapidly evolving. The era of digital recording systems (e.g., DVR, Tivo, etc.) to record, or “time-shift” content is on the increase. In many cases, a user will time shift when broadcast times conflict with work or family obligations, or other schedule constraints and priorities. A user may consolidate viewing into a few sessions where all or part of the time shifted content is viewed at a later time. In some cases, though time-shifted, the user may never actually consume the content that is recorded.

A user generally time-shifts with an expectation that the same “user experience” will be enjoyed during time-shifted viewing as would be enjoyed with an actual scheduled broadcast. However, as media content is intertwined with the user's larger day to day cultural experience, it is likely that aspects of the time shifted content will be revealed with the passage of time. Thus, the user experience is vulnerable to being “spoiled” for big events, like live sporting events (e.g., Olympics, etc.), because the outcome (winners, scores, plot twists) may be reported on media such as broadcast media, internet media, and so on, by journalists before the user can view the recorded program.

Journalists do not account for time-shifting when deciding on programming content, and most of a journalist's audience are probably not time-shifting programs, and therefore, journalists frequently provide sports scores, comment on popular programs and provide other content that may spoil the experience of those time-shifting particular programs. In other words, programming content is arranged based on an assumption that all content is watched when it is broadcasted. It would be difficult for broadcasters to accommodate users with time-shifted content. The challenge for broadcasters becomes more evident when considering that certain programming is dedicated to reporting on, evaluating, or at least mentioning aspects of previously broadcasted content including previously played sports event, previously run movies, television series, and so on. Examples include the broadcast of sporting event results (e.g., football game scores) that appear in other sports-oriented broadcasts such as end-of-day sports wrap ups. Further examples include shows that provide reviews of movies or TV series. Such shows may provide detailed critical commentary on movies or TV series that recently opened or were broadcasted. Even social media contacts for a particular individual cannot always know when a user has recorded content for later viewing and may send messages to the user that include spoiler content.

In some instances conventional spoiler alerts may be provided, such as when broadcasters report on sporting events taking place in distant time zones (e.g., the Olympics). The conventional “spoiler alert” may involve the voluntary manual placement of an audible (e.g., spoken) or textual warning. The conventional voluntary spoiler alert may be manually placed at the beginning of a critical review of a movie, a social media post, or an oral message from a broadcast announcer. However, such conventional “spoiler alerts” are often ineffective at providing enough notice for the user to leave the room, mute the volume, and so on. Further, conventional spoiler alerts do not take into account the need to provide such an alert, to whom such alert should be provided, or may not cover all potential spoiler content.

### SUMMARY

The various embodiments include in a communication networking framework having a content presenting device and a mobile computing device configured to communicate with each other, methods and devices implementing the methods for blocking spoiler content from being presented by the content presenting device. An embodiment method may include operations performed by the content presenting device. The operations may include receiving one or more spoiler alert events from the mobile computing device, each of the one or more spoiler alert events including information associated with content that has not been viewed by a user of the mobile computing device. The operations may further include comparing the information with content to be presented by the content presenting device. The operations may further include determining whether the content to be presented by the content presenting device includes the spoiler content based on the comparison and restricting a presentation of the spoiler content in the content to be presented by the content presenting device based on determining that the content to be presented includes the spoiler content.

Operations of an embodiment method may further include determining whether the content associated with the one or more spoiler alert events has been viewed by the user of the mobile computing device and clearing the one or more spoiler alert events associated with the content that has not been viewed by the user of the mobile computing device when the content has been viewed by the user of the mobile computing device based on the determination.

In an embodiment method, receiving one or more spoiler alert events from the mobile computing device to the content presenting device using the communication networking framework may include discovering a presence of the mobile computing device using the communication networking framework, receiving from the mobile computing device the one or more spoiler alert events and the information about the content that has not been viewed, and storing the one or more spoiler alert events and the information about the content that has not been viewed in a storage location accessible to the content presenting device.

In an embodiment method, the information associated with the content that has not been viewed may include one or more of a name of the content, a broadcast time of the content; a blocking release time of the content; and one or more keywords associated with the content. Further in the embodiment method, comparing the information with content to be presented by the content presenting device may include scanning the content to be presented for one or more of the name of the content; the broadcast time of the content; the blocking release time of the content; and the one or more keywords associated with the content.

Further in the embodiment method, restricting the presentation of the spoiler content in the content to be presented by the content presenting device based on determining that the content to be presented includes the spoiler content may include restricting the presentation of the spoiler content based on one or more rules.

Further in an embodiment method, the one or more rules may include a rule restricting a presentation of the spoiler content based on a location zone of the mobile computing device such that: when the location zone includes a first location zone closest to the content presenting device, a video portion and an audio portion of the spoiler content are fully restricted; when the location zone includes a second location zone farther from the content presenting device than the first location zone, the video portion and the audio portion of the spoiler content are partially restricted; and when the location zone includes a third location zone farther from the content presenting device than the first location zone and the second location zone, the video portion of the spoiler content is not restricted and the audio portion of the spoiler content is restricted.

Further in an embodiment method, the one or more rules may include one or more of the following: a rule restricting a presentation of the spoiler content based on a majority count of mobile computing devices providing spoiler alert events for the same content compared to a total count of a plurality of mobile computing devices in proximity to the content presenting device; a rule restricting a presentation of the spoiler content based on a relative weight of a first one of the one or more spoiler alert events for a first one of the plurality of mobile computing devices in proximity to the content presenting device compared to a relative weight of a second one of the one or more spoiler alert events for a second one of the plurality of mobile computing devices in proximity to the content presenting device; a rule restricting a presentation of the spoiler content based on an age of the one or more spoiler alert events, wherein the presentation of the spoiler content is not restricted when the age of the one or more spoiler alert events is older than a threshold age; a rule restricting a presentation of the spoiler content based on a content type of the content to be presented by the content presenting device; a rule restricting a presentation of the spoiler content based on a maximum blocking time, wherein the presentation of the spoiler content is not restricted after the maximum blocking time expires; a rule restricting a presentation of the spoiler content based on a paid subscription service, wherein the presentation of the spoiler content associated with one of the one or more spoiler alert events for a given mobile computing device is restricted when a subscription fee associated with the given mobile computing device has been paid; a rule enabling a presentation of the spoiler content when the presentation of the spoiler content is otherwise restricted by one or more other rules and providing a spoiler alert indication that indicates to the given mobile computing device that the presentation of the spoiler content will not be restricted; and a rule that presents the content that has not been viewed based on determining whether a sufficient number of mobile computing devices that have registered one of the one or more spoiler alert events for the same content are in proximity to the presenting device and when a sufficient number of the plurality of mobile computing devices are present, presenting an offer to be displayed on each of the plurality of mobile computing devices to present the content that has not been viewed, and presenting the content that has not been viewed when a sufficient number of the plurality of mobile computing devices accept the offer.

Further embodiments include a content presenting device having a transceiver and a processor configured with processor-executable instructions to perform operations of the embodiment methods described above. In some embodiments, a content presenting device may include means for performing operations of the embodiment methods described above.

Further embodiments may include a non-transitory processor-readable storage medium on which are stored processor-executable instructions to perform operations of the embodiment methods described above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1A is a system diagram illustrating components of a spoiler alert system suitable for use in the various embodiments.

FIG. 1B is a diagram illustrating program content time shifting suitable for use in the various embodiments.

FIG. 1C is a graph illustrating program content time shifting suitable for use in the various embodiments.

FIG. 1D is a graph further illustrating program content time shifting suitable for use in the various embodiments.

FIG. 2A is a diagram illustrating a content presenting device and a mobile computing devices positioned in various alert zones and blocking zones in the various embodiments.

FIG. 2B is a diagram illustrating additional embodiment content presenting devices and embodiment mobile computing devices in public mass consumption instances in the various embodiments.

FIG. 3 is a message flow diagram illustrating networking framework messages between content presenting devices and mobile computing devices for device discovery and spoiler alert Event information in the various embodiments.

FIG. 4A is a process flow diagram illustrating an embodiment method for consumption device discovery by a content presenting device and spoiler alert and content blocking.

FIG. 4B is a process flow diagram illustrating an embodiment method for applying zone-based rules for spoiler alert and content blocking.

FIG. 4C is a process flow diagram illustrating an embodiment method for generating, updating and clearing Spoiler Alert Event listings for a mobile computing device.

FIG. 4D is a process flow diagram illustrating an embodiment method for generating, updating and clearing Spoiler Alert Event listings for a content presenting device.

FIG. 5A-FIG. 5I are process flow diagrams illustrating embodiment methods for the application of spoiler alert and content blocking rules.

FIG. 5J is a process flow diagram illustrating an embodiment method for the conditional presentation of recorded content associated with the spoiler alert.

FIG. 6 is a component diagram of an example mobile computing device suitable for use with the various embodiments.

FIG. 7 is a component diagram of an example mobile computing device suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The terms “networking framework” and “communication networking framework” as used herein refer interchangeably to a communications framework, an applications framework, and organized systems of communication and application-interaction protocols and commands for facilitating device-to-device (e.g., peer-to-peer or “P2P”) and application-to-application communications, interaction and control. A networking framework may be implemented as a collection of Application Programming Interfaces (APIs), Software Development Kits (SDSKs), and other application or system software that collectively provide standard mechanisms and interface definitions to enable interfacing between controlling and controlled devices coupled through a communication network that may be an ad-hoc network. The various APIs and SDKs may provide high level access (e.g., from an application layer) to functions that would normally be accessed or controlled at a lower layer in a software architecture. Such functions may include, but are not limited to, ad-hoc networking, security, pairing, device discovery, service discovery, platform transparency, radio access control, message formatting, message transmission, message reception and decoding, and so on. An example of a comprehensive networking framework is the AllJoyn® Core Framework initially developed by Qualcomm Innovation Center and presently hosted by the Allseen Alliance.

An AllJoyn® Core Framework may include a set of service frameworks that are simple and enable users to interact with nearby similarly configured computing devices. An example of a set of service frameworks may include: Device Information & Configuration—the device broadcasts information such as device type, manufacturer and serial numbers; also allows the user to assign a name and password to the device; Onboarding—allows objects to be easily connected (e.g., via an intermediary such as an access point) to the user's network; Notifications—objects may broadcast and receive basic communications (e.g., text, image/video, audio, control, status); Control Panel—a control device such as a smartphone or tablet may control another object via a graphical interface (e.g., GUI or UI); and Audio—audio source objects may stream to selected AllJoyn®-enabled speakers, audio receivers and other audio playback smart objects.

The various embodiments enable distributed, dispersed or ad-hoc networks among various communication devices to work in a collaborative manner in order to avoid displaying or playing content that would “spoil” the experience of user who has recorded one or more programming events, regardless of the user's location. The embodiments may utilize a networking framework (e.g., an Alljoyn® framework) that enables various communication devices to inform other devices in an ad hoc manner about programs that could be spoiled by broadcasts and perform other functions in order to enable communication devices to display or present audio spoilers. Spoilers are avoided by a mobile computing device of the user leveraging distributed communication networks to identify to content displaying devices (e.g., smart televisions, radios, tickertape marquees, computers with large displays, etc.) an ID, programming information, or a characterization of the recorded program. The content displaying devices may monitor current programming for potential spoiler events in a variety of ways. The content being displayed may be parsed for content related to the reported program in order to determine whether the content contains spoilers. In some embodiments, the currently displayed content may have tags associated with embedded potential spoiler content that can be parsed and read by the content displaying device. In some embodiments, data associated with the current broadcast may be buffered to facilitate parsing. For example, the audio data may be parsed by the content displaying devices to determine whether spoiler content is present. In some embodiments, social media posts, SMS text/audio/video messages, emails associated with the user's computing device may be blocked when they contain spoiler content.

As discussed, a spoiler may be considered to be content that discloses revealing information (e.g., score, movie ending, critical detail) about the time-shifted event, having the effect of “spoiling” the expected user experience of the user recording the event. Spoilers may appear in many forms including on other media devices that the user may encounter (e.g., office break room television), and within the visual or audible content that appear within the user's view or hearing. Spoilers may be in the form of a ticker on a news broadcast, a “Tweet”, a tickertape marquee, a Facebook post, an advertisement, an SMS message, an email, an audio broadcast, or virtually any media transmission.

The term “Spoiler Alert Event,” is used herein refer to an event that indicates the existence of time shifted content. A Spoiler Alert Event may include issuing a command to record content using a digital television recorder (DTR) or other media recording device. Other examples of spoiler events may include an email or message broadcast to social media contacts indicating that a command to record content has been given or that content has been recorded. In various embodiments, Spoiler Alert Events may be “registered” with a networking framework in a number of ways that may including providing a list of all time-shifted content that has not been viewed. A Spoiler Alert Event may contain information about the time shifted content including the time and date that the event will air, and information about the time-shifted content allows a content presenting device or a system or networking framework component to identify content associated with the current broadcast that may be relevant to the time shifted content. When a mobile communication device registers with a networking framework, such as an Alljoyn® framework, the list of time-shifted content and relevant information about the time-shifted content may form the basis for providing spoiler alerts and content blocking in the various embodiments.

The term “spoiler alert” is used herein to refer to a message that is displayed on a content presenting device, such as a television screen, or on the mobile communication device of a user, such as in the form of a message, email, or other notification indicating that upcoming content that may be displayed in a content displaying device may have a spoiling effect on items associated with a particular Spoiler Alert Event (e.g., time shifted content).

The term “content blocking,” which may in some instances be used together with a spoiler alert, is used to refer to the blocking of content related to time-shifted content or programming that has not yet been viewed. Content blocking may be carried out to prevent viewing of the related content, such as by a user who has registered a Spoiler Alert Event, and therefore “spoiling” of a user experience by the viewing of the content. Content blocking may include blanking of tickers, blanking of close captioned text, muting all or portions of audio, blanking the entire display screen, blocking social media messages, blocking emails, or blanking or blocking other media presentation mechanisms that include information relevant to the time-shifted programming.

When possible, and in accordance with various blocking rules, the spoiling content may be blocked. For example, the content presenting device or devices may mute audio and/or blank their screens when the spoiling content would otherwise be viewable or audible to a user recording a program (i.e., time-shifting the program). If the spoiling content cannot be blocked (e.g., the content presenting devices are public and the conditions of a blocking rule are not satisfied), the content presenting device may send a message (e.g., a spoiler alert) to the user's mobile device so that an audible and/or visual alert may be issued. The alert may enable the user to look away or walk away from the content presenting device.

In some embodiments, a Spoiler Alert Event may be detected or reported for a user by the user's mobile communication device (e.g., a smartphone). Other devices in the ad hoc network that may be capable of presenting potential spoiler content may be informed of the Spoiler Alert Event. Devices owned by the user (e.g., smartphone, iPad, Smart TV, etc) and any networking framework-enabled, and/or spoiler alert service-enabled devices that are in proximity of the user are able to talk to each other via an ad hoc communication network, such as a peer-to-peer networking framework (e.g., an AllJoyn® framework), that is supported using WiFi, NAN (Neighborhood Area Network), LTE Direct, Bluetooth, Bluetooth Low Energy, etc. A spoiler alert application may be installed on the user mobile communication device and on content display devices that display content or receive communications that could include spoilers (e.g., email). The spoiler alert application on the user mobile communication device may track Spoiler Alert Events (e.g., recorded programming). The spoiler alert application on the other devices may receive the information regarding the spoiler alert condition (e.g., Spoiler Alert Event). An application programming interface (API) call may be used to create or register the Spoiler Alert Event, signaling that an event which may require a spoiler alert has been registered.

Information about the Spoiler Alert Event, such as the program that may give rise to a spoiler alert, may be obtained from a source such as from a program guide. The information may be provided in the Spoiler Alert Event. Alternatively or in addition, the Spoiler Alert Event may contain sufficient information for a receiving device to look up program guide information for the program contained in the Spoiler Alert Event. The content presenting device may further monitor currently broadcast content for spoiler related content. The content presenting device or devices may parse the information being received or information about programming that will be received. The content presenting device or devices may compare that information to the Spoiler Alert Event, and perform actions to help the user avoid being exposed to spoiler information such as by providing spoiler alerts and/or content blocking. Content presenting devices configured with a spoiler alert application may selectively block spoiler content; when content cannot be blocked, notify the user's device to issue an alert so the user can avoid seeing/hearing content; or some combination of spoiler alerts and content blocking. spoiler alert generation may also be conditioned based on the proximity of the user/device to the content presenting device such that the spoiler content may be blocked only when the user is close enough to see/hear the spoiler content.

In some embodiments, the content presenting device may establish content blocking zones based on proximity. The content presenting device may receive information identifying the mobile computing devices that are close by and the distance of each device to the content presenting device. Mobile computing devices may be classified based on various distance zones using their determined proximity. The zones may be established based on factors related perceptibility, such as the size of the display screen, the level of the audio, and so on. These factors may influence the ability of users within the different distance zones to be able to hear and/or see the content being presented by the content presenting device. Thus, a large display (e.g., a tickertape marquees or a large screen TV) that a person could see from a relatively long distance may have a large visual blocking distance zone and a moderate (or no) audio blocking zone, while a small television or laptop computer may have a relatively small visual blocking zone but a larger audio blocking zone because a person may not be able to make out scores or tickers from far away but may be able to hear the audio if it is turned up to a high volume.

In response to receiving content that may be associated with a registered Spoiler Alert Event, a content presenting device may perform various actions to parse or filter content to determine whether a spoiler is embedded in the content. Examples of such actions in various embodiments include: intercepting TCP/IP packets and examining the contents for spoiler text; performing optical character recognition (OCR) on graphics renderings, which may be stored in a display buffer, and blocking any spoiler text; executing a word filtering application; intercepting Twitter/Facebook/email/SMS messages and parsing for those that contain spoiler text; and so on.

In various embodiments, content blocking by content displaying devices may be performed or inhibited based on rules. Examples of rules may include voting rules, priority rules, time since Spoiler Alert Event was registered, type/importance of current content, and so on, examples of which are described in greater detail herein after.

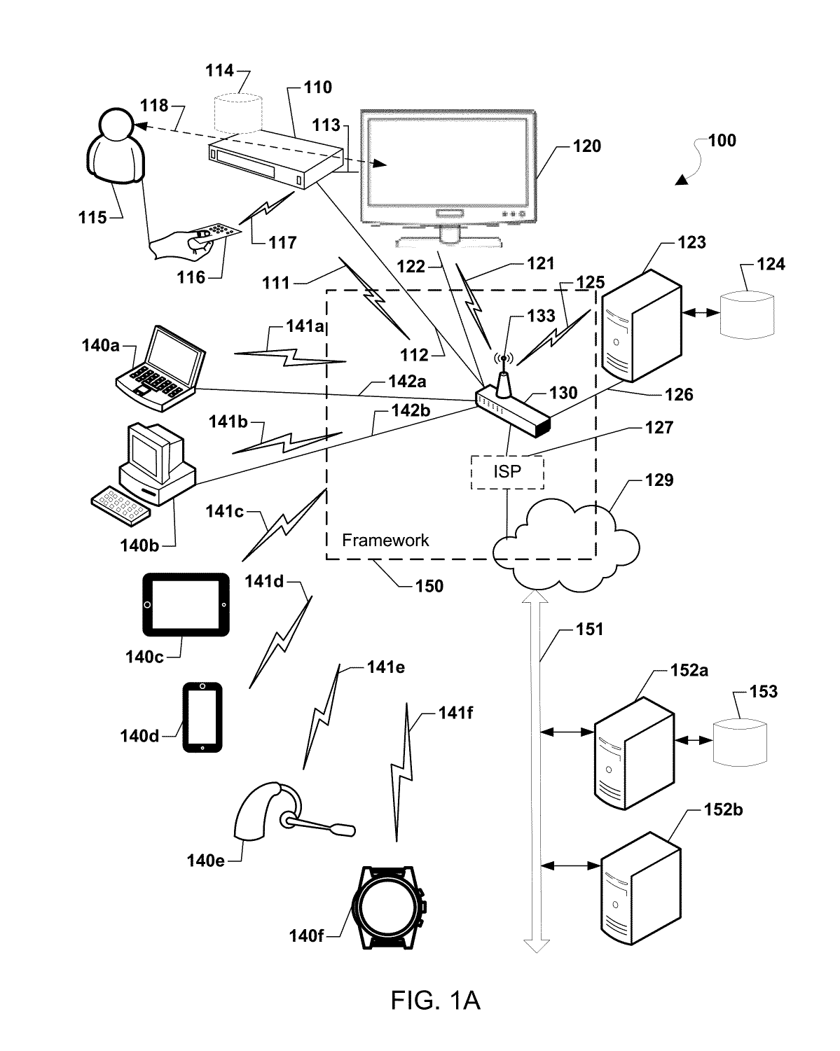

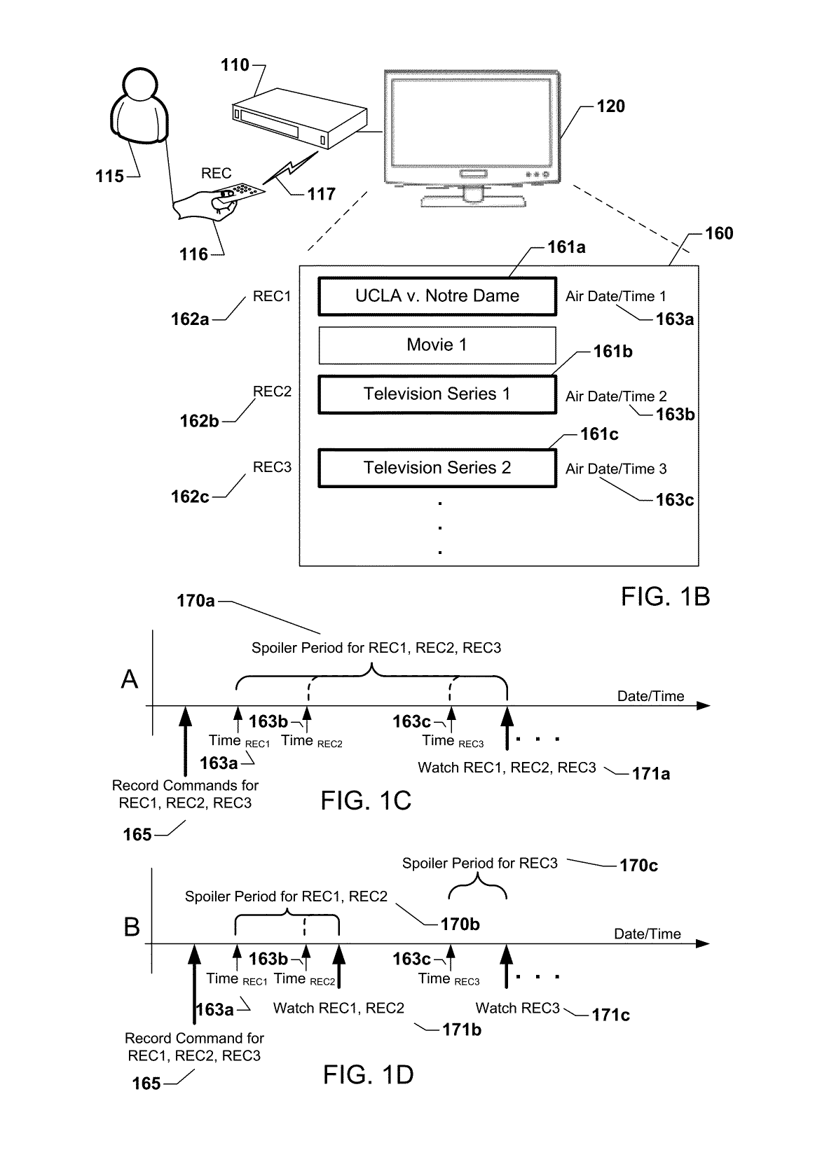

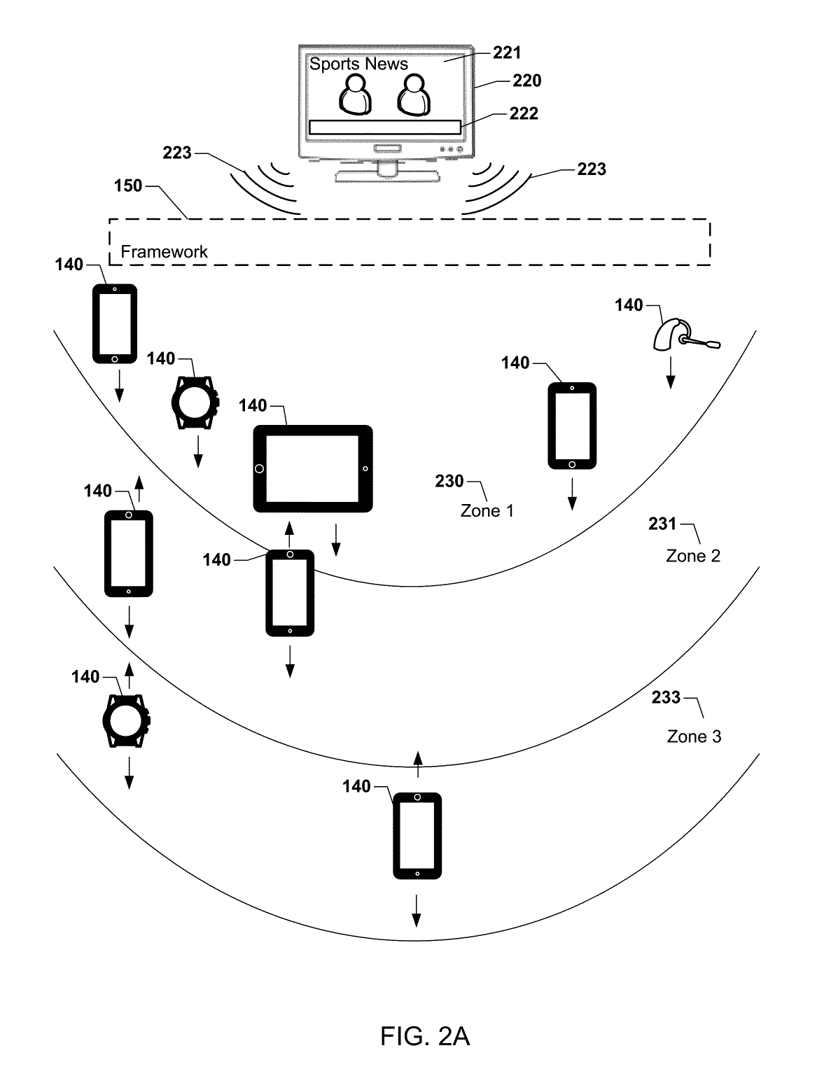

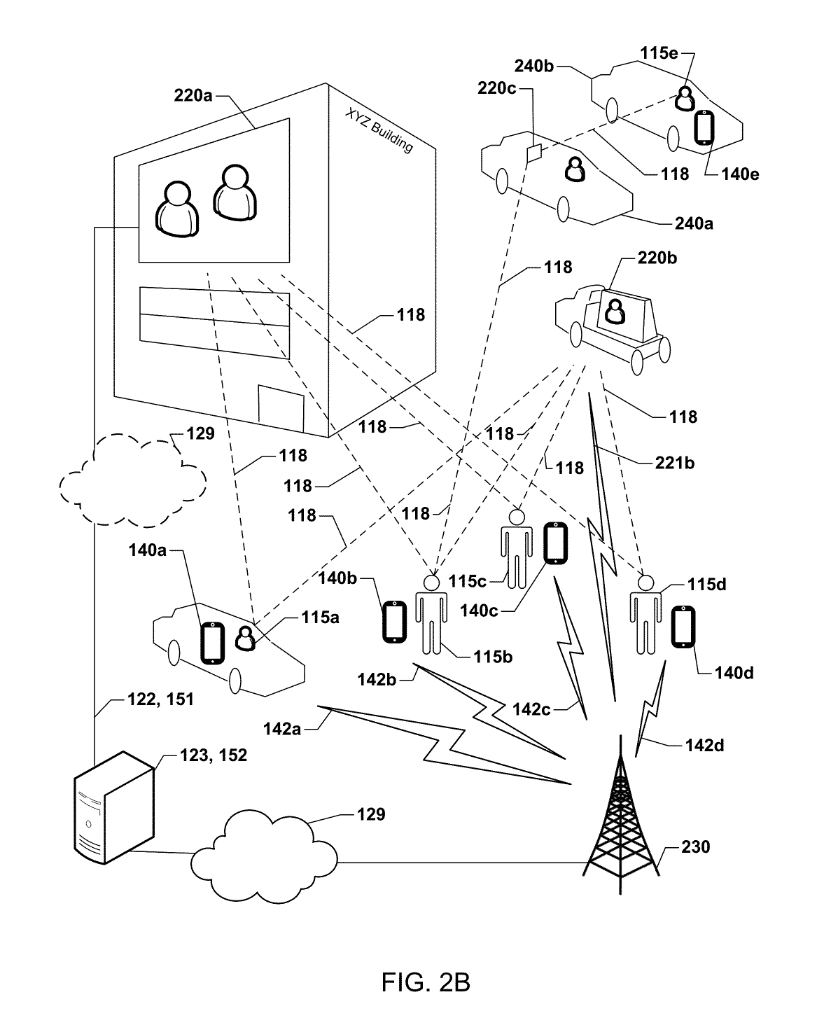

The various embodiments may be implemented within a variety of electronic communication environments, such as private networks, public networks, ad hoc (i.e., device-to-device) networks, or combinations of private, public and ad hoc networks. An example communication network 100 is illustrated in FIG. 1A. In an embodiment, the communication network 100 may include computing devices 140a-140f, which may be mobile computing devices. The computing devices 140a-140f may be content displaying devices and/or mobile computing devices carried by a user to a location where content is being presented by content presenting devices 120. The computing devices 140a-140f may consume various content in the form of social media posts, email messages, or in some instances, programming content itself. Those computing devices 140a-140f displaying content, which are referred to herein as content displaying devices, may block programming content presented on themselves when near a user 115 who has or is recording a program and whose mobile computing device is configured to inform content displaying devices 140a-140f of the desire to block spoiler events.

Blocking may be conducted by content displaying devices based on the presence of one or more of the computing devices 140a-140f requesting blocking of spoiler events and the registration of information that allows a content presenting device to determine the content to block. Indications may be provided to the computing devices 140a-140f about the blocked content including spoiler alerts as described in greater detail hereinafter. The computing devices 140a-140f may be carried by a user and thus be with the user when he/she is in a position to observe content on a content presenting device, such as broadcast content including movie content, television content, audio content, and so on. The computing devices 140a-140f may be configured to receive or consume social media content, including email messages, SMS messages, Instant Messages, Facebook posts, Twitter posts, and so on. In the various embodiments, the computing devices 140a-140f may include without limitation, a laptop computing device 140a, a desktop computing device 140b, a tablet computing device 140c, a smart phone 140d, a wireless earpiece 140e, a wireless media-capable watch 140f, and so on. The computing devices 140a-140f may be coupled wirelessly to an access point 130, through wireless links 141a-141f. In some instances, a wired link, such as wireless links 142a and 142b may be established between the laptop computing device 140a, the desktop computing device 140b and the access point 130.

In various embodiments, alternatively or in addition to content being presented on the computing devices 140a-140f, content may be presented on a content presenting device 120. The content presenting device 120 may be any device configured to present content, such as television screen in a home, or a public place, such as in a workplace break room, electronic billboard, mobile electronic billboard, and so on. In some instances, the content presenting device 120 may be a display device of a user that is viewable by others, such as a display in an automobile. The content presenting device 120 may be coupled to an access point 130 through a wireless link 121 and/or a wired link 122. The content presenting device 120 may further be connected to a content distribution unit 110, such as a set top box, cable box, and so on. The content distribution unit 110 may be connected to the access point 130 through a wireless link 111 and/or a wired link 112.

In some embodiments, the content distribution unit 110 may provide content selected by a user 115 through interaction with the content distribution unit 110 using a remote control device 116, which may provide commands to the content distribution unit 110 over a control link 117. The content may be provided to the content distribution unit 110 by an independent service provider 127, such as through the access point 130. The independent service provider 127 may be a provider of subscription based content such as a telephone, cable, or internet provider, or combinations of these subscription based services. The content may be provided to the content presenting device 120 from the content distribution unit 110 through a direct link 113, which may be a wired or wireless link.

The communication network 100 may further include a server 123, such as a private server for a private portion of the communication network 100. The server 123 may be coupled to the access point 130 through a wireless link 125 and/or a wired link 126. The server 123 may have a mass storage element 124 or elements. Alternatively or in addition, the mass storage element 124 may be external to the server 123. The communication network 100 may further include a connection to a public network, such as the Internet 129, such as through the independent service provider 127. In some embodiments, the content may include content obtained through the Internet 129. The communication network 100 may further include servers 152a and 152b that may be coupled to or be integrated with one or more mass storage elements 153. The servers 152a and 152b may be remote servers associated with providing content of the independent service provider 127, or may be remote servers associated with third party content that is accessible by the user 115 using Universal Resource Locators (URLs). In some embodiments, the user 115 may view content on the content presenting device 120 along a content consumption line or a view 118, which may represent generally a line of sight, a line of hearing, and so on.

In the various embodiments, communication, control and interaction between the various mobile computing devices and content displaying devices may be facilitated using a networking framework 150, which may be a networking framework such as an Alljoyn® framework. The networking framework 150 may provide platform independent API calls that allow the computing devices to advertise presence, communicate capabilities, give and receive control commands, status messages, and so on. For example, based on information received via the networking framework 150 from one of the computing devices 140a-140f, the content presenting device 120 may determine whether content should be blocked to avoid spoiler events.

In the various embodiments, the user 115 may program a content recording device 114 or recording capability associated with the content distribution unit 110 through interaction with the remote control device 116 having a control link 117 with the content recording device 114. In some embodiments, the content recording device 114 may be incorporated into the content distribution unit 110. Alternatively or in addition, the content recording device 114 may be an external recording device, which may be coupled to the content distribution unit 110. For example, the content recording device 114 may receive content from the content distribution unit 110 or may be independently coupled to a source of content. The content recording device 114 may be compatible with the networking framework 150.

In various embodiments, as illustrated in FIG. 1B, FIG. 1C and FIG. 1D, the content distribution unit 110 and/or the content recording device 114 may be configured as a set top box, such as to provide control over channel selection for content display of content presenting device 120. Content may be selected by a user for recording from a program guide 160 as illustrated in FIG. 1B. The program guide 160 may display several selections for viewing or recording. The program guide 160 may display an event 161a, which may be a sporting event (e.g., “UCLA vs. Notre Dame”), an event 161b, which may be a Television Series 1, and an event 161c, which may be a Television Series 2. Each of the events may be accompanied by an air time and date. For example, the event 161a may be aired at an Air Date/Time 1 163a, the event 161b may be aired at an Air Date/Time 2 163b, and the event 161c may be aired at an Air Date/Time 1 163c. Commands may be given to record the events 161a-161c, such as through interaction between the user 115 and the remote 116. For example, the user 115 may give a command REC1 162a to record the event 161a at the Air Date/Time 163a, the user 115 may give a command REC2 162b to record the event 161b at the Air Date/Time 163b, the user 115 may further give a command REC3 162c to record the event 161c at the Air Date/Time 163c. The above events and recording commands are representative, additional or fewer commands for events to be recorded may be generated. However, for a Spoiler Alert Event to be generated, a command for recording at least one program event may be necessary.

As further illustrated in FIG. 1C, as commands are generated to record events, spoiler periods may be established between the time the event airs and the time the content is consumed. In some embodiments, such as illustrated in graph A, a user may issue the command REC1 162a, the command REC2 162b and the command REC3 162c at approximately the same command time 165 for the event 161a, the event 161b and the event 161c. A spoiler alert time period 170a may indicate the start and end time during which spoiler alerts and content blocking may be generated for spoiler content on the mobile computing device 140 of the user 115 or on any content presenting device 120 (or devices) to which the user 115 may come into proximity. In some embodiments, the spoiler alert time period 170a may begin for all events at or near the beginning of the Air Date/Time 163a of the first recorded event, such as the event 161a. The spoiler alert time period 170a may end when the user 115 has consumed the content at a watch time 171a, when the event 161a, the event 161b, and the event 161c are watched. During the spoiler alert time period 170a, the air date and time of the other events may also transpire such as the Air Date/Time 163b for the event 161b, and the Air Date/Time 163c for the event 161c. When the spoiler alert time period 170a ends at the watch time 171a, no further spoiler alerts and content blocking may be generated for the user 115 since all time-shifted content has been consumed, or at least has begun to be consumed. In the various embodiments, spoiler alerts and content blocking may continue until watching or consumption has been completed. Alternatively, a separate spoiler alert time period 170a may begin at different times for different content as show by the dotted lines corresponding to the beginning of the Air Date/Time 163b for event 161b, and the Air Date/Time 163c for the event 161c.

As illustrated in FIG. 1D, commands may be generated to record events, content may be viewed, and multiple spoiler periods may be established between the time the event airs and the time the content is consumed. In some embodiments, such as illustrated in graph B, a user may issue the command REC3 162a, the command REC2 162b and the command REC3 162c at approximately the same command time 165 for the event 161a, the event 161b and the event 161c. In some embodiments, recording commands may be issued at different times. A spoiler alert time period 170b may indicate the start and end time during which spoiler alerts and content blocking may be generated for spoiler content on the mobile computing device 140 of the user 115 or on any content presenting device 120 (or devices) to which the user 115 may come into proximity. The spoiler alert time period 170b may begin at or near the beginning of the Air Date/Time 163a of the first recorded event, such as the event 161a. The spoiler alert time period 170a may end when the user 115 has consumed the content at a watch time 171b, when the event 161a and the event 161b are watched. During the spoiler alert time period 170b, the air date and time of the other events may also transpire such as the Air Date/Time 163b for the event 161b. When the spoiler alert time period 170b ends at the watch time 171b, no further spoiler alerts and content blocking may be generated for the user 115 for the event 161a and the event 161b since that content has been consumed. Alternatively, separate spoiler alert time periods 170b may begin at different times for different content as show by the dotted line corresponding to the beginning of the Air Date/Time 163b for event 161b. An additional spoiler alert time period 170c may be started for the event 161c. The additional spoiler alert time period 170c may end when the user 115 has consumed, or at least has begun to consume the content at the watch time 171c, such as when the event 161c is watched.

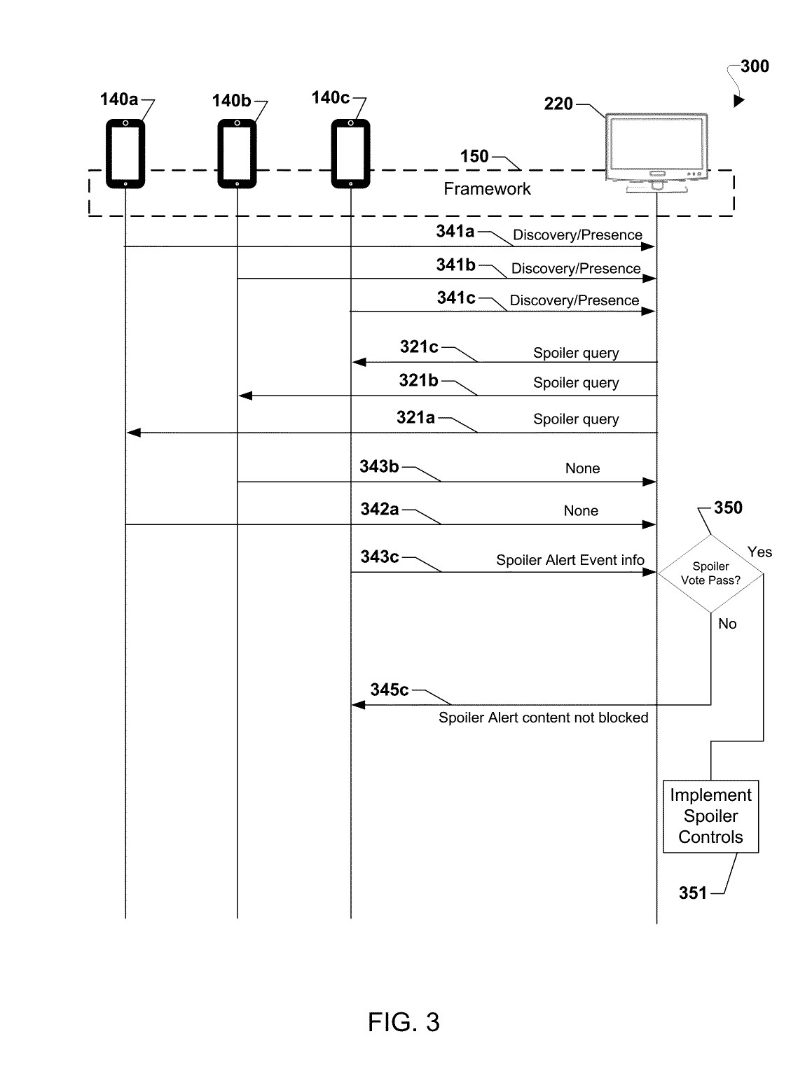

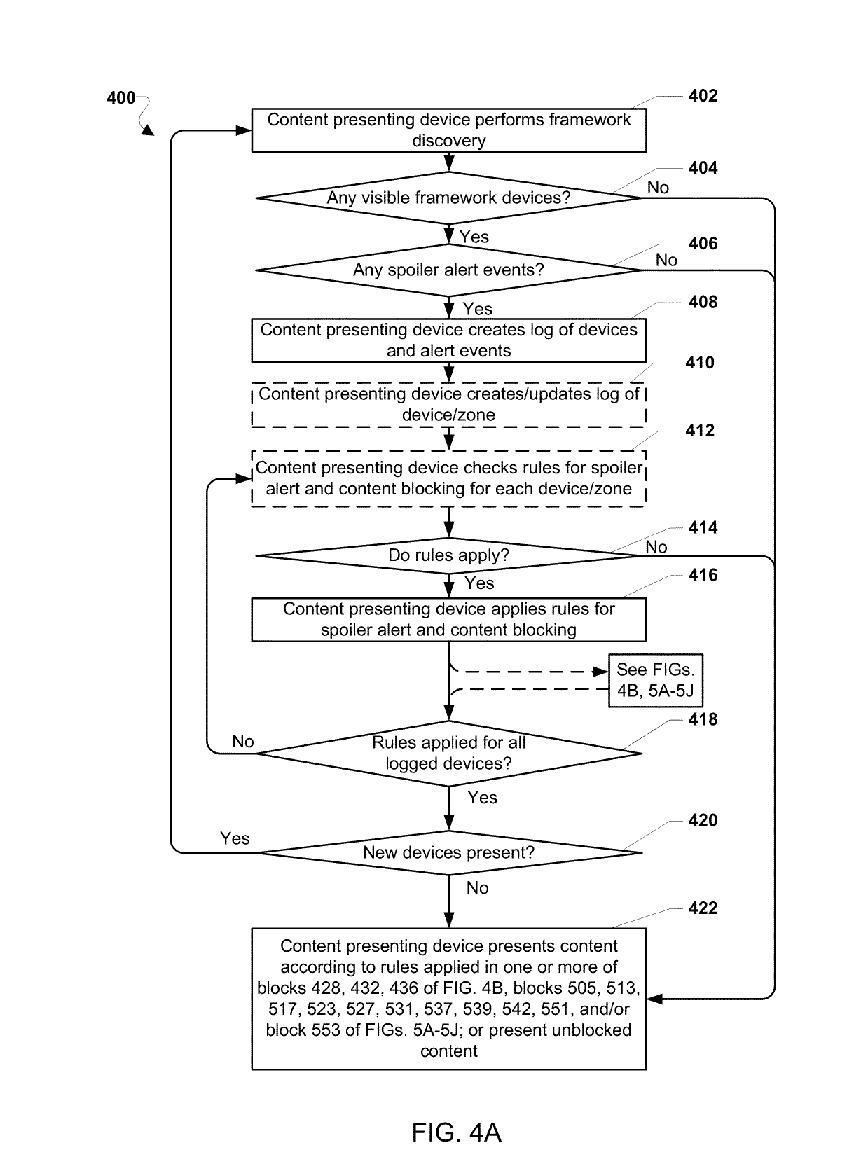

In some embodiments, a content presenting device, such as the content presenting device 220 illustrated in FIG. 2A, may be in a setting such as a public or semi-public (e.g., workplace) area. The content presenting device may have a basic presentation area, such as a display area 221 on which a main program is being presented. The content presenting device 220 may further include a ticker display area, such as a portion 222, on which information that is supplementary or completely unrelated to the main program may be displayed in a cycling fashion, such as informative text that scrolls through the ticker display area or the portion 222. The content presenting device 220 may play sound from a speaker based on a received audio signal 223 associated with the main content.

The content presenting device 220 may be located in an area where various ones of the mobile computing devices 140 may come into and move out of proximity thereto. When a mobile computing device 140 moves within radio range of the content presenting device 220, the mobile computing device 140 may be discovered by the content presenting device 220 and/or the mobile computing device 140 may discover the content presenting device 220, such as through commands, requests, messages, and so on, associated with the networking framework 150. The networking framework commands, requests, and messages may be transmitted, received, exchanged between the mobile computing device 140 and the content presenting device 220 to facilitate communication, control, and interaction between the computing devices. For example, the content presenting device 220 may receive an advertisement of presence of the mobile computing device 140 through a message associated with the networking framework 150.

The content presenting device 220 may further obtain information about the proximity of the mobile computing device 140, such as through calculating the range of the radio signals received from the mobile computing device 140, from location coordinates (e.g., GPS) associated with the mobile computing device 140 and so on. Based on the proximity information, the content presenting device may associate the mobile computing device 140 with one of several zones, such as a Zone 1 230, a Zone 2 231, or a Zone 3 233. The Zone 1 230 may represent the zone that is closest to the content presenting device 220, and therefore the zone in which users associated with the mobile computing devices 140 may be able to clearly see presentation content and hear presentation content audio of the content presenting device 220, even at a reduced volume. The Zone 2 231 may represent the zone that is farther away from the content presenting device 220 than the Zone 1 230. Users of the mobile computing devices 140 within the Zone 2 231 may still have a clear view of the content presenting device 220, but the ability of the audio to be detected by the users of the mobile computing devices 140 may be diminished. The Zone 3 233 may represent the zone that is farthest away but that may still require some degree of spoiler alert or content blocking action. Any users of mobile computing devices 140 within the Zone 3 233 may have a limited view of the presentation content and the limited hearing of the presentation content audio.

In the various embodiments, the content presenting device 220 may determine the relative position or at least the distance of the mobile computing devices 140 and thus the relative positions of the respective users 115, and may conduct spoiler alert and content blocking for the respective users 115 based on the position of the mobile computing devices 140 within the zones. For example, the users 115 of the mobile computing devices 140 within the Zone 1 230 will require complete display and audio blocking when a spoiler alert event is detected and the rules allow for content blocking. For the users 115 of the mobile computing devices 140 in other zones, the content blocking associated with content blocking for the Zone 1 230 will effectively block content for all zones. Therefore, for the users 115 of the mobile computing devices 140 in the other zones which do not have spoiler alerts for the blocked content associated with the mobile computing devices 140 in the Zone 1 230, the users 115 of the mobile computing devices 140 in the other zones will nevertheless be subjected to content blocking.

The users 115 of the mobile computing devices 140 in the Zone 2 231 may require a reduced degree of blocking. Thus, for spoiler alert events that are exclusive to the users 115 of the mobile computing devices 140 in the Zone 2 231, for example, presentation content and presentation content audio may be effectively blocked by a reduction in brightness or similar display characteristic, a reduced volume, or other less than total blocking. For example, the display 221 of the content presenting device 220 or the portion 222 of the display 221 (or both) may be adjusted such that a brightness level, gray level, contrast level, or other parameter, is raised or lowered such that only viewers within a certain distance of the content presenting device 220, such as the users of the mobile computing devices 140 in the Zone 1 230, may be able to see the content. Further, the content presenting device 220 may reduce the volume or frequency characteristics of the audio such that it cannot be clearly heard by viewers in the Zone 2 231 or the Zone 3 233, but can be heard in the Zone 1 230.

The users 115 of the mobile computing devices 140 in the Zone 3 233 may require a further reduced degree of blocking. Thus, for spoiler alert events that are exclusive to the users 115 of the mobile computing devices 140 in the Zone 3 233, presentation content and presentation content audio may be effectively blocked by a smaller degree of reduction in brightness or similar display characteristic, a reduced volume, or other less than total blocking than the reduction required for the Zone 2 231. For example, the display 221 of the content presenting device 220 or the portion 222 of the display 221 (or both) may be adjusted such that a brightness level, gray level, contrast level, or other parameter, is raised or lowered such that only viewers within a certain distance of the content presenting device 220, such as the users of the mobile computing devices 140 in the Zone 1 230, and the Zone 2 231 may be able to see the content. Further, the content presenting device 220 may reduce the volume or frequency characteristics of the audio such that it can be heard by viewers in the Zone 1 230, and the Zone 2 231 but cannot be clearly heard in the Zone 3 233.

In some embodiments, the mobile computing devices 140 may play a masking sound to obfuscate the content from a content presenting device 220. For example, the mobile computing device 140 may play an audio stream that is timed to coincide with the presentation of the spoiler content on the content presenting device 220. As another example, the mobile computing device 140 may generate a ring tone that causes a user 115 to engage with the mobile computing device 140, such as raise the device to the ear of the user 115, at which point the computing device may play an audio stream that overcomes the content of the content presenting device or warns the user about the spoiler content playing on the content presenting device 220.

In the various embodiments, the users 115a-115d of the computing devices 140a-140d may be in a public setting such as walking outside or driving, as illustrated in FIG. 2B. When the users 115a-115d are walking or driving, a public content presenting device 220a, such as an electronic billboard or tickertape marquees on the side of a building may be encountered. The users 115a-115d will have their own respective views 118 of the public content presenting device 220a and the content being displayed depending on their location, intervening structures, intervening noise, etc. When walking or driving, the users 115a-115d may encounter a public content presenting device 220b such as a mobile billboard attached to a vehicle such as a truck or other vehicle and may have respective views 118 of the displayed content of the public content presenting device 220b. In some embodiments, spoiler content that may be displayed on the public content presenting devices 220a and 220b may be blocked and/or spoiler alerts may be generated by receiving Spoiler Alert Event information from some or all of the computing devices 140a-140d of the users 115a-115d.

In some situations, the vehicle may be a private passenger vehicle, such as a vehicle 240a with a content presenting device 220c that is visible to a pedestrian user 115b or a user 115e in an adjacent vehicle 240b through views 118. In some embodiments, spoiler content that may be displayed on the content presenting device 220c of the private passenger vehicle may be blocked and/or spoiler alerts may be generated by receiving Spoiler Alert Event information from at least the computing devices 140b and 140e of the users 115b and 115e. In embodiments, additional position and motion information may be processed with regard to the positions of the vehicles 240a and 240b to determine whether spoiler blocking should be performed. For example, if private vehicles, such as the vehicles 240a and 240b are approaching each other, and at least one of the vehicles is equipped with a content presenting device 220c, capable of presenting spoiler content, additional measures, such as GPS location and movement direction and speed may be used to predict when the vehicles 240a and 240b may be in proximity to each other as illustrated. Spoiler Events may be registered with the content presenting device 220c by the approaching vehicle 240b in the manner described herein so as to provide spoiler related actions to prevent the spoiler content on the content presenting device 220c. Alternatively or in addition, spoiler alerts may be provided to the user 115e with computing device 140e in the approaching vehicle 240b. As another example, the vehicle 240a having the content presenting device 220c may be approaching the vehicle 240b (or other vehicles), or the vehicles 240a and 240b may be travelling adjacent to each other along the same route. As a further example, both vehicles 240a and 240b may include content presenting devices and perform different content blocking actions depending upon the time-shifting actions taken by the respective vehicle occupants.

In some embodiments, the public content presenting device 220a may be coupled to one or more of the remote server 123, 152 through links 122, 151 to the Internet 129. The public content presenting device 220b may be coupled to one or more of the remote server 123, 152 through a wireless connection 221b, such as a cellular connection to a cellular infrastructure component 230. Further, the computing devices 140a-140d may be coupled to one or more remote servers 123, 152 through respective wireless links 142a-142d to the cellular infrastructure component 230.

When computing devices 140a-140d and the public content presenting devices 220a, 220b are executing the networking framework 150, the computing devices 140a-140d may be discovered by the public content presenting devices 220a, 220b through networking framework mechanisms. Alternatively or in addition, the computing devices 140a-140d may discover the public content presenting devices 220a, 220b. Upon discovery, the computing devices 140a-140d may transfer any Spoiler Alert Event information to the public content presenting devices 220a, 220b. The public content presenting devices 220a, 220b may perform content blocking and/or provide spoiler alerts to the computing devices 140a-140d as described herein. The content blocking and spoiler alerts may be subject to the application of rules. In some embodiments, the public content presenting devices 220a and 220b may encounter a large number of the computing devices 140a-140d during operation due to being located in public spaces. Therefore, management of the spoiler alert and content blocking may be facilitated by external servers that are networking framework compatible.

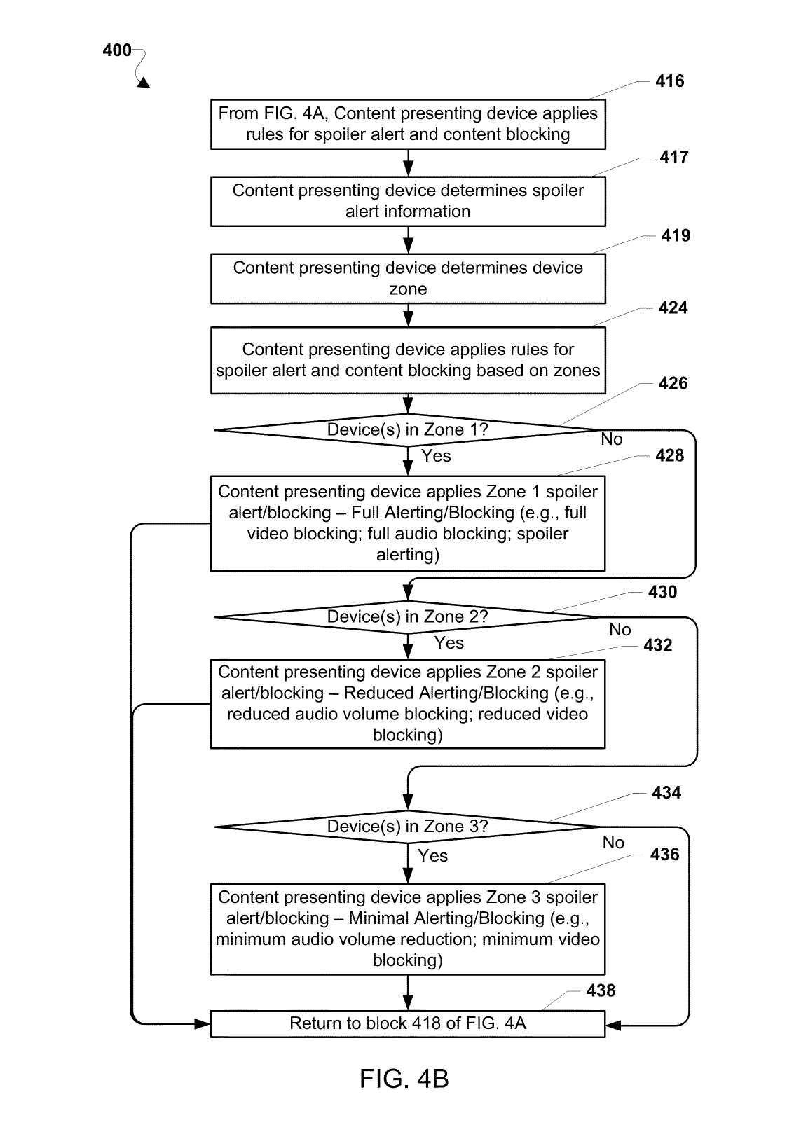

In some embodiments, the networking framework 150 may provide an API or suitable messaging mechanism for the computing devices to perform discovery, Spoiler Alert Event information transfer, and other functions to enable content blocking and spoiler alert generation as illustrated in FIG. 3. For example, when the computing devices 140a-140c enter communication range of the content presenting device 220, networking framework discovery messages 341a-341c may be sent to the content presenting device 220, facilitated by the networking framework 150. The networking framework discovery messages 341a-341c may advertise the presence of the computing devices 140a-140c to the content presenting device 220. The networking framework discovery messages 341a-341c may include information about the computing devices such as device type, device capabilities, device ID, and/or other information. The content presenting device 220 may also make at least a preliminary determination of the range of the computing devices 140a-140c based on the radio communication parameters associated with the messages (e.g., RSSI). The networking framework discovery messages 341a-341c may further contain location information associated with respective ones of the computing devices 140a-140c.

When the content presenting device 220 receives the networking framework discovery messages 341a-341c, networking framework query messages 321a-321c may be sent from the content presenting device 220 to the mobile computing device 140a-140c. In some embodiments, the networking framework query messages 321a-321c may specifically inquire whether the computing devices 140a-140c have any Spoiler Alert Event information. In the illustrated example the networking framework query messages 321a-321c are sent as separate messages to the computing devices 140a-140c. In other examples, a networking framework broadcast message (not shown) may be sent to alert any devices to send spoiler related information to the content presenting device 220.

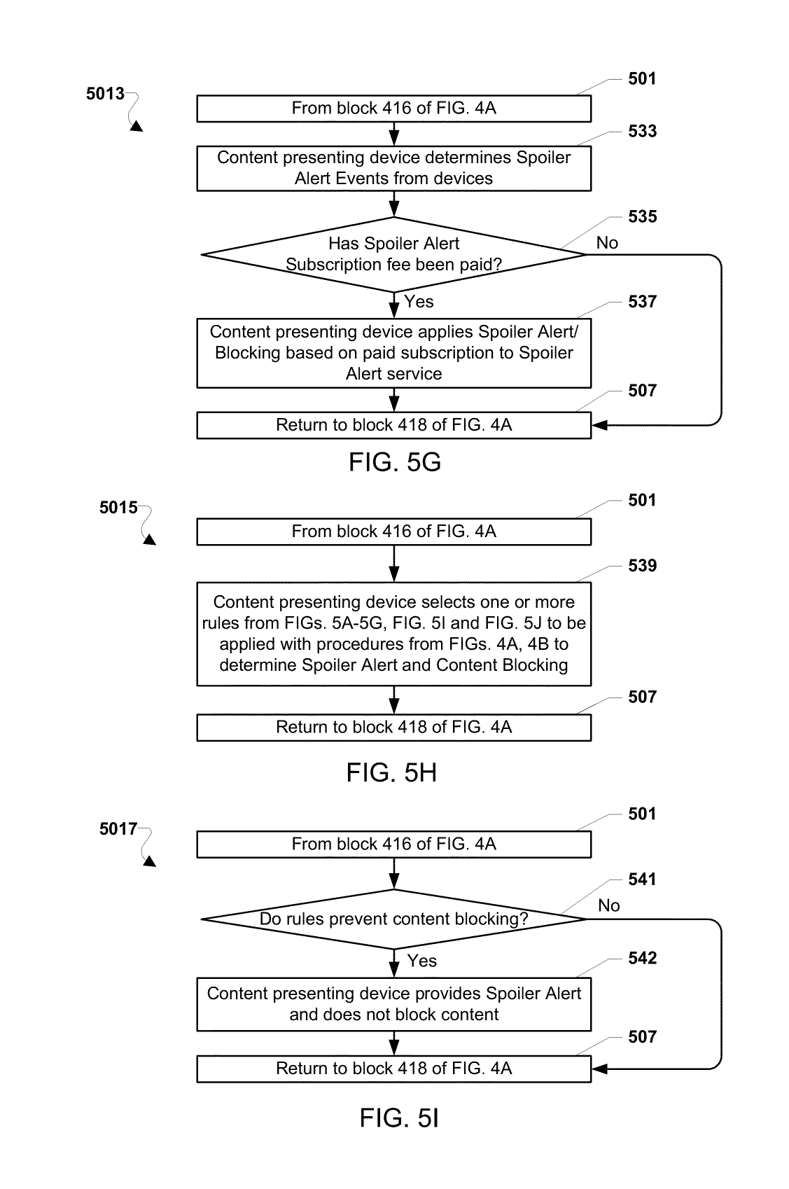

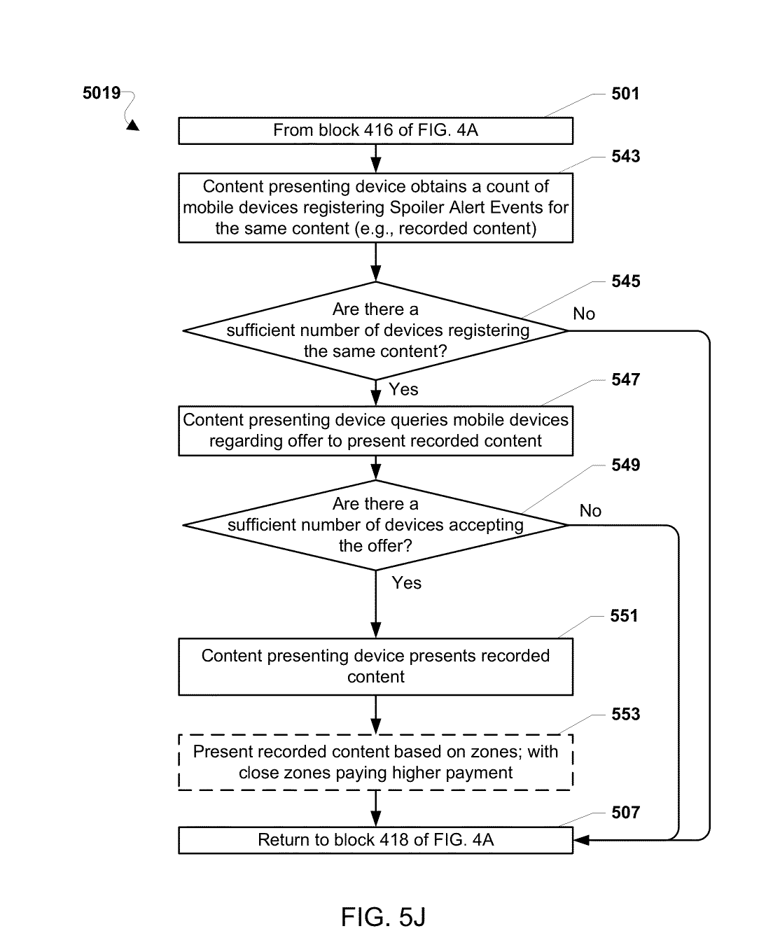

The computing devices 140a-140c may send networking framework response messages in response to the networking framework query messages 321a-321c. For example, the mobile computing device 140b may send a networking framework response message 343b indicating that no Spoiler Alert Event information is available for the device. The mobile computing device 140a may send a networking framework response message 343a indicating that no Spoiler Alert Event information is available for the device. The mobile computing device 140c may send a networking framework response message 343c that contains Spoiler Alert Event information. When the networking framework response message 343c containing the Spoiler Alert Event information is received by the content presenting device 220, a processor of the content presenting device 220 may determine whether rules, such as a voting rule, allow content to be blocked. Embodiment voting rules and other rules are described in greater detail herein below in connection with FIG. 5A-5J. In response to determining that the spoiler alert vote is passed (i.e., determination block 350=“Yes”), the processor may implement spoiler controls in block 351. Spoiler controls may include controls based on the zone in which the mobile computing device 140c is located, or other considerations. In response to determining that the spoiler alert vote does not pass (i.e., determination block 350=“No”), the processor may cause a networking framework message 345c, such as a spoiler alert message, to be sent from the content presenting device 220 to the mobile computing device 140c indicating that content associated with the Spoiler Alert Event will not be blocked.

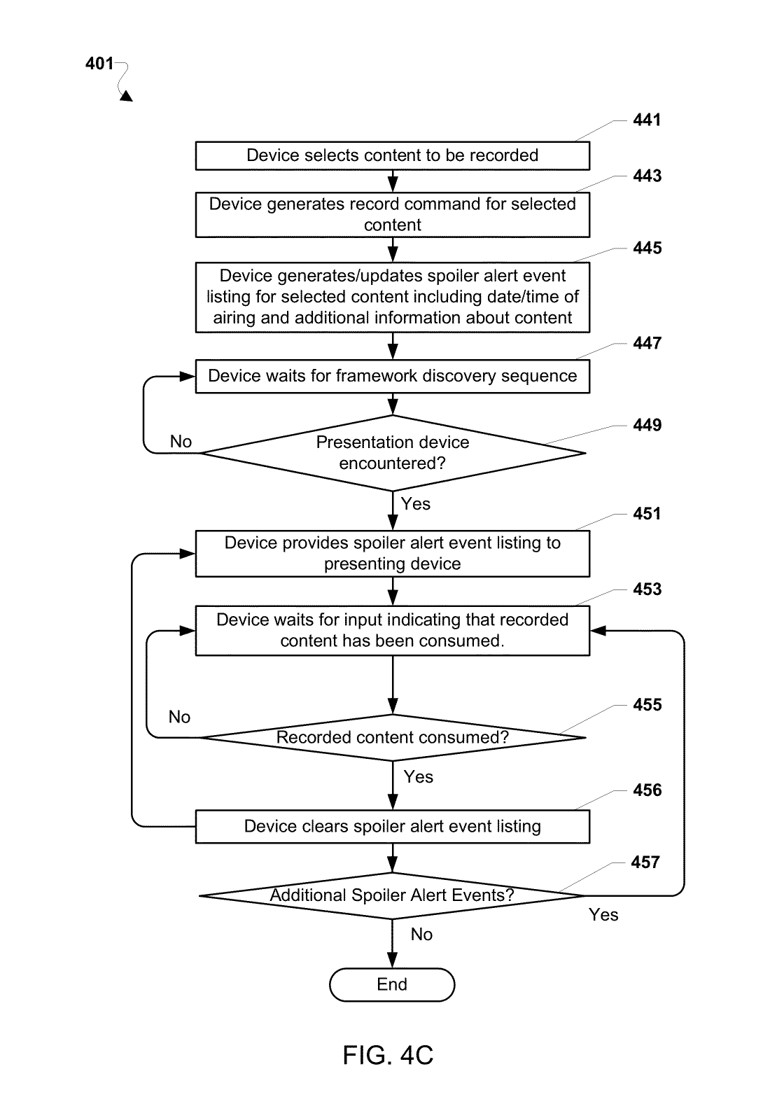

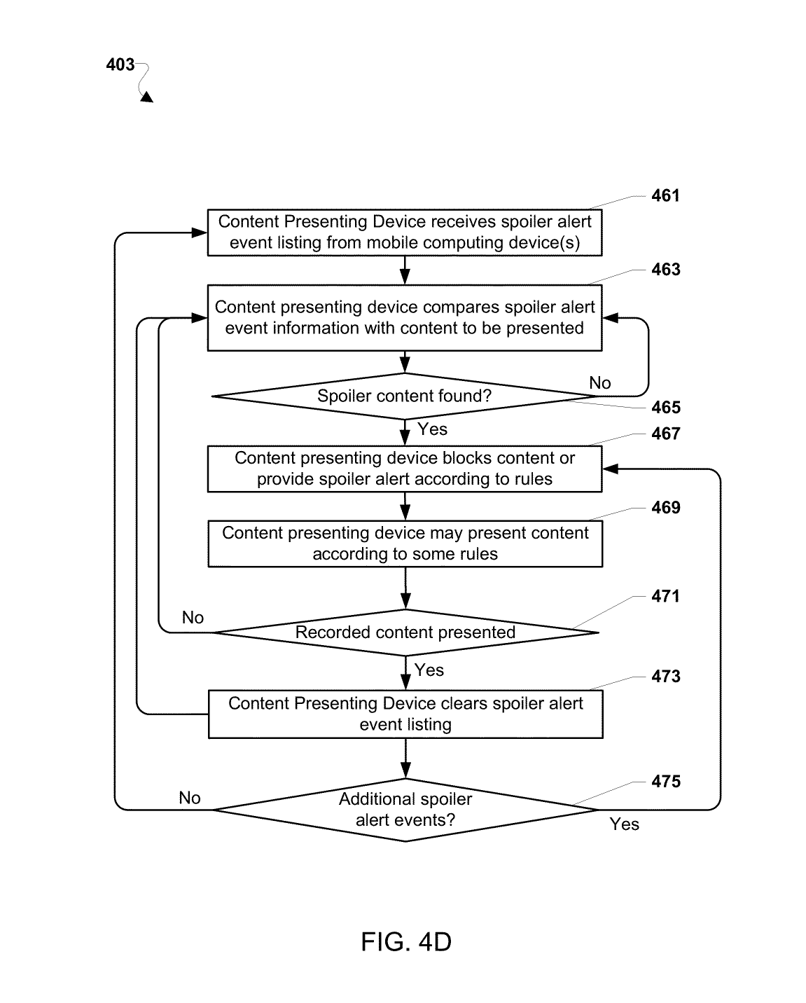

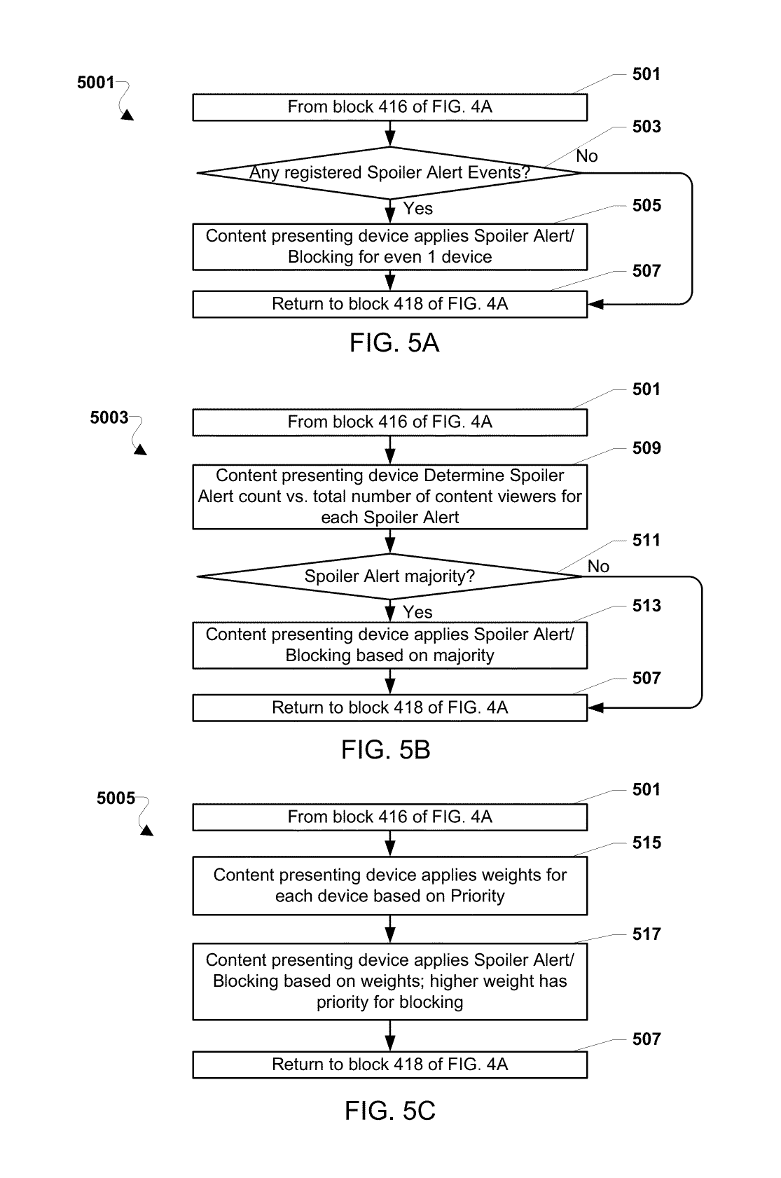

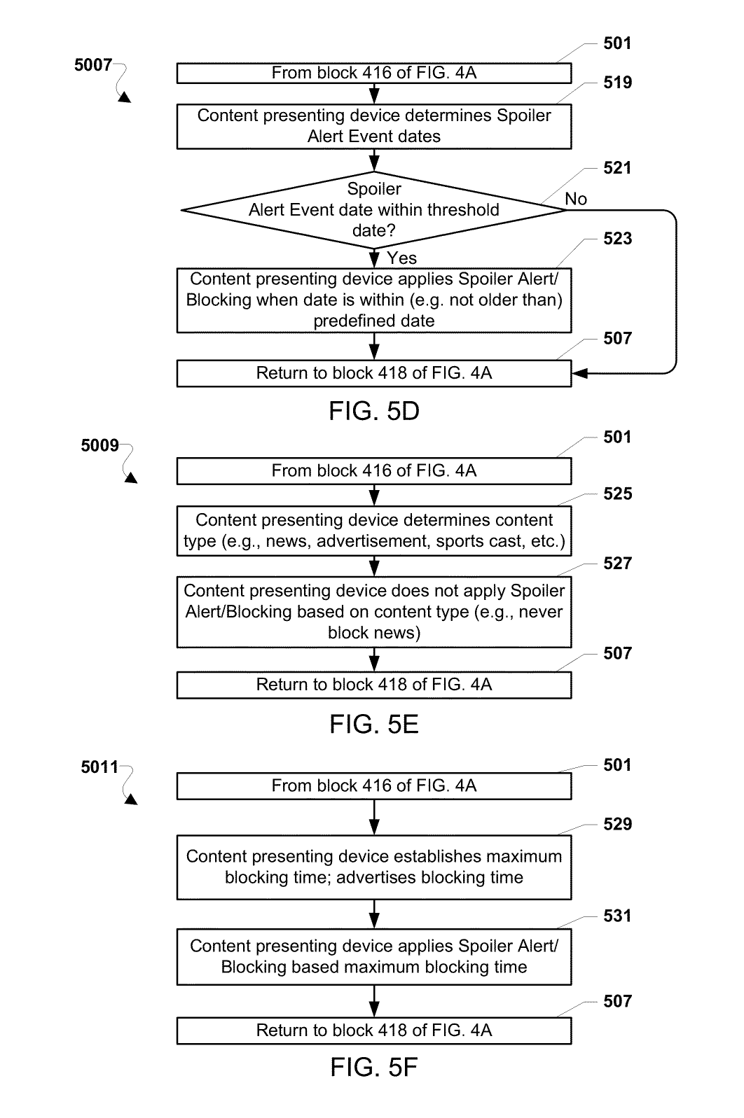

An embodiment method 400 for device discovery and content blocking is illustrated in FIGS. 4A-4B. Referring to FIG. 4A, in block 402, a processor or processors, such as may be associated with a content presenting device (and one or more mobile computing devices), may perform networking framework discovery. As described herein, networking framework discovery may include the transmission and reception by the processor or processors of networking framework discovery messages. The framework discovery may inform devices of each other's presence and may allow devices to share information, such as information about each device's capabilities, identity, and other information.

In determination block 404, the processor of a content presenting device may determine whether any networking framework compatible devices are present. In response to determining that networking framework compatible devices are present (i.e., determination block 404=“Yes”), the processor may determine whether any Spoiler Alert Events are present in determination block 406. The processor may determine the presence of Spoiler Alert Events as described herein by sending networking framework query messages and receiving networking framework responses from the discovered devices and obtaining Spoiler Alert Event information from the devices.

In response to determining that no networking framework devices are present (i.e., determination block 404=“No”), the processor may present content without blocking in block 422. In various embodiments, the processor may present the content subject to the application of rules, such as rules applied in connection with any one or more of blocks 428, 432, 436 of the method 400 (FIG. 4B), and blocks 505, 513, 517, 523, 527, 531, 537, 539, 542, 551, and/or block 553 of the methods described below with reference to FIGS. 5A-5J.

In response to determining that Spoiler Alert Events are present (i.e., determination block 406=“Yes”), the processor may create a log entry associated with the device and the Spoiler Alert Event or events in block 408. In response to determining that no Spoiler Alert Events are present (i.e., determination block 406=“No”), the processor may present content without blocking in block 422. As noted, the processor may present the content subject to the application of rules, such as rules applied in connection with blocks 428, 432, 436 of the method 400 (FIG. 4B), and blocks 505, 513, 517, 523, 527, 531, 537, 539, 542, 551, and/or block 553 of the methods described below with reference to FIGS. 5A-5J.

In block 410, in an optional zone-based implementation, the processor of the content presenting device may create or update a log of Spoiler Alert Event information for each device in each zone. Further, in block 412, in the optional zone-based implementation, the processor may check rules associated with spoiler alert and content blocking for each device in each zone. Alternatively, when a zone-based implementation is not being used, the processor may check the rules for each device. In determination block 414, the processor may determine whether any rules apply to spoiler alert and content blocking. In response to determining that one or more rules apply (i.e., determination block 414=“Yes”), the processor of the content presenting device may apply those rules for spoiler alert and content blocking in block 416. In the various embodiments, the rules may be applied as described below with reference to one or more of FIGS. 4B, 5A-5J. For example, if a voting rule applies, the processor may check for a vote count for blocking particular content. When the vote totals in favor of blocking, the processor may block content associated with the Spoiler Alert Event log information. Other examples of rules are described herein. The application of rules for content blocking and spoiler alert generation is further described with reference to FIG. 4B, and FIG. 5A-5J. In response to determining that the rules do not apply (i.e., determination block 414=“No”), the processor may present the content without blocking in block 422.

In determination block 418, the processor may determine whether rules have been applied for all logged devices. The logged devices may include devices for which spoiler content has been logged. In some embodiments, a logged device may be a device that is logged as being present (e.g., in proximity to/discovered by the content presenting device) but may not include any listed spoiler content. Such devices may nevertheless be considered in determining the application of rules because such devices may participate in or become subject to the application of rules without logging spoiler content. For example, such devices may be considered in content voting rules without having logged spoiler content.

In response to determining that rules have been applied for all the discovered devices, such as by determining that rules have been applied or accounted for in connection with all of the logged Spoiler Alert Event information (i.e., determination block 418=“Yes”), the processor may determine whether any new devices have entered within range in determination block 420. For example, the processor may determine whether the networking framework discovery process has discovered the presences of any new devices, such as detected within proximity to the content presenting device. In response to determining that the rules have not been applied for all the discovered devices (i.e., determination block 418=“No”), the processor may return to block 412 to check for and apply additional rules.

In response to determining that new devices are present (i.e., determination block 420=“Yes”), the processor may return to block 402 to perform networking framework discovery for the new device or devices. In some embodiments, the processor may learn of the presence of new devices from the networking framework discovery process and may perform additional networking framework processing in block 402, which may include discovery processing. In some embodiments, the processor may determine that new devices are present by receiving networking framework presence messages from the new devices and may return to block 402 to perform network framework discovery, such as obtaining additional information about the new device or devices. In response to determining that no new devices are present (i.e., determination block 420=“No”), the processor may present at least some of the content without blocking in block 422. Alternatively or additionally, the processor may present at least some of the content subject to the application (or previous application) of rules, such as rules applied in connection with blocks 428, 432, 436 of the method 400 (FIG. 4B), and blocks 505, 513, 517, 523, 527, 531, 537, 539, 542, 551, and/or block 553 of the methods described with reference to FIGS. 5A-5J.

In the various embodiments, the degree of content blocking may be determined and performed according to various zones as described with reference to FIG. 2A. Thus, further in the embodiment method 400 as illustrated in FIG. 4B, the application of rules may be based on a zone implementation. As described above, different zones may be associated with different distances from the content presenting device. In such a zone configuration, different levels of content blocking may be performed by the processor according to the zone in which is located a mobile computing device that requested the spoiler blocking, such as by logging spoiler-related information. In block 416, as described above, the processor may apply rules for spoiler alert and content blocking. In block 417, the processor may determine spoiler alert information, such as by receiving networking framework messages from devices containing Spoiler Alert Event information. In block 419, the processor may determine the zone for each mobile computing device (and user).

In block 424, the processor may apply rules for providing spoiler alerts and performing content blocking based on the determined zones of the devices. In determination block 426, the processor may determine whether any devices (and associated users) are in Zone 1, which may be the zone closest to the content presenting device in which full content blocking measures may be appropriate. In response to determining that there is at least one device having at least one logged Spoiler Alert Event in Zone 1 (i.e., determination block 426=“Yes”), the processor may apply Zone 1 spoiler alert and content blocking parameters in block 428. For example, the processor may perform full video and audio blocking in block 428, subject to the possible application of additional rules. As another example, if the application of content blocking rules for a given zone prevents content blocking, the processor may send spoiler alerts to the user's mobile computing device to alert the user of the device that a spoiler is imminent in block 428. The processor may proceed to determination block 418 of FIG. 4A for further processing. In response to determining that no devices are present in Zone 1 (i.e., determination block 426=“No”), the processor may determine whether any devices are present in Zone 2 in determination block 430.

In response to determining that at least one device is present in Zone 2, (i.e., determination block 430=“Yes”), the processor may apply Zone 2 spoiler alert and content blocking parameters in block 432. For example, the processor may perform reduced video and audio blocking in block 432, subject to the possible application of additional rules. For example, if application of content blocking rules prevents content blocking, the processor may send spoiler alerts to alert the user of the device that a spoiler is imminent in block 432. The processor may proceed to determination block 418 of FIG. 4A for further processing. In response to determining that no devices are present in Zone 2 (i.e., determination block 430=“No”), the processor may determine whether any devices are present in Zone 3 in determination block 434.

In response to determining that at least one device is present in Zone 3, (i.e., determination block 434=“Yes”), the processor may apply Zone 3 spoiler alert and content blocking parameters in block 436. For example, the processor may perform minimal video and audio blocking in block 436, subject to the possible application of additional rules. Alternatively, the processor may not perform blocking and may send only spoiler alerts. For example, if application of content blocking rules prevents content blocking, the processor may send spoiler alerts to alert the user of the device that a spoiler is imminent in block 436. Because users of mobile computing devices located in Zone 3 are far from the content presenting device, the processor may send only spoiler alerts to the computing devices in Zone 3. The spoiler alerts may alert the users of the computing devices to avoid moving into a closer zone such as Zone 1 or Zone 2. The alerts may be useful when content blocking rules would preclude content blocking. The processor may proceed to determination block 418 of FIG. 4A for further processing. In response to determining that no devices are present in Zone 3 (i.e., determination block 434=“No”), the processor may proceed to determination block 418 of FIG. 4A for further processing. For ease of description and illustration, the various embodiments use examples involving three zones. However, more or fewer zones may also be possible in some embodiments, such as two, four, or more zones. The zones are described herein for ease of illustration as being based on progressive radial distances; however, zones may be configured differently, such as based on radial orientation, sector orientation, block orientation, etc.

In the various embodiments, as described above, content blocking and the generation of spoiler alerts may be based on reception by a content presenting device of networking framework messages from mobile computing devices containing information about recorded programming of users of the mobile computing devices. Thus, in an embodiment method 401, as illustrated in FIG. 4C, a processor of a mobile computing device may generate spoiler alert Event information. The Spoiler Alert Event information may be communicated to and used by a content presenting device to determine the generation of appropriate spoiler alert and/or content blocking. In block 441, the processor of the mobile computing device may select the content to be recorded, such as from a program guide or other index or catalog provided by a content provider or distributor. Alternatively or additionally, the selected content may already be pre-recorded content, such as a sports event, movie, or series episode that the user has not yet viewed, such as pre-recorded content offered by a video service provider. In block 443, the processor of the mobile computing device may generate a record command for one or more selected items of programming content, such as through interaction with a digital recording device. In block 445, the processor of the mobile computing device may generate or update a Spoiler Alert Event listing for the selected content. The processor of the mobile computing device may include information such as name, air time/date, and other information in the Spoiler Alert Event listing, that is sufficient to allow a content presenting device to identify potential spoiler content in broadcasted or presented content, such as when the Spoiler Alert Event listing is communicated to the content presenting device (e.g. during device discovery).

In block 447, the processor of the mobile computing device may wait until a networking framework discovery operation, networking framework query, or other opportunity to transfer the Spoiler Alert Event information occurs. In determination block 449, the processor of the mobile computing device may determine whether a content presenting device has been encountered, such as through a networking framework discovery process. In response to determining that a content presenting device has been discovered (i.e., determination block 449=“Yes”), the processor of the mobile computing device may provide the Spoiler Alert Event information to a content presenting device in block 451. For example, the processor of the mobile computing device may provide information, such as the listing of Spoiler Alert Events and information that was generated in block 445. In response to determining that a content presenting device has not been encountered (i.e., determination block 449=“No”), the processor of the mobile computing device may continue to wait for a networking framework discovery sequence in block 447.

In block 453, the processor of the mobile computing device may wait for input indicating that the recording content has been consumed. For example, the user of the mobile computing device may view the recorded content on the mobile computing device. When the user has completed viewing the recorded content on the mobile computing device, the user may manually indicate that the content has been viewed. Alternatively or additionally, the processor of the mobile computing device may automatically determine that the recorded content has been viewed.

In determination block 455, the processor of the mobile computing device may determine whether the recorded content has been consumed (e.g., watching the content on a television at a user residence or on a mobile device). The consumption of the content may be determined in a number of ways, including interactions between a user of the mobile computing device and a spoiler alert application that is running on the mobile computing device. For example, the processor of the mobile computing device may receive the input described above in block 453. Alternatively or additionally, the processor of the mobile computing device may automatically determine that the recorded content has been consumed, such as by comparing a listing associated with the recorded content and a listing of content viewing history. In response to determining that the recorded content has been consumed (i.e., determination block 455=“Yes”), the processor of the mobile computing device may clear the Spoiler Alert Event listing from the listing of spoiler information in block 456 and may further update the Spoiler Alert Event listing in block 451. In response to determining that the recorded content has not been consumed (i.e., determination block 455=“No”), the processor of the mobile computing device may continue to wait for an indication that the recorded content has been consumed in block 453.

In determination block 457, the processor of the mobile computing device may determine whether additional Spoiler Alert Events remain in the listing. In response to determining that additional Spoiler Alert Events remain in the listing (i.e., determination block 457=“Yes”), the processor of the mobile computing device may continue to wait for an indication that the recorded event associated with the remaining Spoiler Alert Events has been consumed in block 452. In response to determining that there are no more Spoiler Alert Events do not remain (i.e., determination block 457=“No”), the processor of the mobile computing device may complete processing. Alternatively, the processor of the mobile computing device may register additional Spoiler Alert Events, such as ones that are entered by the user after discovery by the content presenting device. Such newly registered Spoiler Alert Events may be passed to the content presenting device using networking framework messages.

In an embodiment method 403 illustrated in FIG. 4D, a processor of a content presenting device may receive Spoiler Alert Event information from mobile computing devices discovered using the networking framework. In block 461, the processor of the content presenting device may receive Spoiler Alert Events from various mobile computing devices within proximity to the content presenting device. For example, the Spoiler Alert Events may be received and logged with the content presenting device during or after networking framework discovery. In block 463, the processor of content presenting device may compare the Spoiler Alert Event information associated with the Spoiler Alert Events received from one or more mobile computing devices in proximity to the content presenting devices, such as a name of the spoiler content, a broadcast time of the spoiler content, a blocking release time for the spoiler content (e.g., blocking duration), one or more keywords associated with the spoiler content with content to be presented by the content presenting device. For example, in some embodiments, the processor of the content presenting device may parse data in the content to be presented (e.g., program guide information, program listing information, current program title, etc.) and data in the Spoiler Alert Event related information and may compare the parsed data to determine whether any spoiler content is found. In some embodiments, the program guide information may contain further information about embedded spoilers. For example, a news program may provide spoiler content in the form of outcomes of sporting events, in which case spoiler information may be provided in a program guide or listing. In determination block 465, the processor of content presenting device may determine whether spoiler content is found in the content to be presented. In response to determining that spoiler content is found in the content to be presented (i.e., determination block 465=“Yes”), such as based on the comparison in block 463, the processor of content presenting device may block the spoiler content from being displayed or played by the content presenting device in block 467 subject to any active rules as disclosed in greater detail hereinafter. Further, if rules prevent the blocking of spoiler content, the processor of content presenting device may send a spoiler alert to any mobile computing device or devices, for which the spoiler content has been logged, that indicates that spoiler content is being currently presented, may be about to be presented or may be in the process of being presented on the content presenting device. Such an indication or alert may prompt a user of the mobile computing device to avoid coming into proximity to the content presenting device. By “spoiler content,” reference may be made to any content that may be associated with recorded or time-shifted content that a user has recorded such as a sports score, a plot giveaway, a result of a contest, and so on. In response to determining that spoiler content is not found in the content to be presented (i.e., determination block 465=“No”), the processor of content presenting device may continue to parse the content to be presented comparing it with the Spoiler Alert Event-related information in block 463.

In block 469, the processor of the content presenting device may present the recorded content in accordance with some of the rules. For example, if a certain number of the mobile computing devices have registered the same recorded content as a Spoiler Alert Event, the content presenting device, according to a rule, may poll, or request a vote from the audience regarding whether the recorded content should be displayed.

In determination block 471, the processor of the content presenting device may determine whether the recorded content has been presented (e.g., in response to a vote). In response to determining that the content has been presented (i.e., determination block 471=“Yes”), the processor of the content presenting device may clear all of the Spoiler Alert Events (e.g., from various mobile computing devices) associated with the presented recorded content from the current listing in block 473. In some embodiments, the content presenting device may track whether an entirely new audience is present that has logged the same content as a Spoiler Alert Event that was previously presented. In such an instance, the content presenting device may repeat the above described operations as new mobile devices enter and other mobile devices leave proximity to the content presenting device. In response to determining that the recorded content has not been presented (i.e., determination block 471=“No”), the processor of the content presenting device may continue to compare the spoiler alert event information with information about the content to be presented in block 463.

In determination block 475, the processor of the content presenting device may determine whether additional Spoiler Alert Events are listed or logged. In response to determining that additional Spoiler Alert Events are listed (i.e., determination block 475=“Yes”), the processor of the content presenting device may continue to block content or provide spoiler alerts in accordance with rules in block 467. In response to determining that no additional Spoiler Alert Events are listed (i.e., determination block 475=“No”), the processor of the content presenting device may receive additional Spoiler Alert Events as new devices enter proximity in block 461. For example, the processor of the content presenting device may receive a networking framework discovery sequence, such as when a new mobile computing device enters into proximity of the content presenting device. At that time, any new Spoiler Alert Events may be registered. Alternatively or additionally, mobile devices may enter proximity to the content presenting device at any time, at which time Spoiler Alert Events may be registered, such as during discovery. Further, devices already registered with the networking framework and the content presenting device (e.g., after discovery has occurred) may update their spoiler information by sending any new Spoiler Alert Events to the content presenting device using networking framework messages.

I

In the various embodiments, content blocking and generating spoiler alerts may be based on various rules in the embodiment methods described herein. Examples of methods implementing such rules are illustrated in FIG. 5A through FIG. 5J. In block 501 of the method 5001 illustrated in FIG. 5A, a processor of a content presenting device may proceed from applying rules in block 416 of the method 400 described above with reference to FIG. 4A and apply blocking for any discovered device or devices that have registered Spoiler Alert Events. In determination block 503, the processor of a content presenting device may determine whether there are any registered Spoiler Alert Events, such as whether any devices have provided Spoiler Alert Event information. In response to determining that at least one device has provided a Spoiler Alert Event (i.e., determination block 503=“Yes”), the processor of a content presenting device may apply content blocking in block 505. For example, subject to the application of any other rules, even if only one discovered device is discovered having Spoiler Alert Events, the content of presenting device may apply rules for content blocking and spoiler alert generation for the single device. The processor of a content presenting device may apply blocking for all received Spoiler Alert Events that are received from discovered devices. In response to determining that no devices have provided a Spoiler Alert Event (i.e., determination block 503=“No”), the processor of a content presenting device may return to determination block 418 of the method 400 described with reference to FIG. 4A in block 507.

In block 501 of the method 5003 illustrated in FIG. 5B, a processor of a content presenting device may proceed from applying rules in block 416 of the method 400 described above with reference to FIG. 4A. In block 509, the processor of a content presenting device may determine a count among the various discovered devices for Spoiler Alert Events for a particular program. For example, if ten devices are discovered, the processor of a content presenting device may determine a count among the ten devices to determine how many of the devices have provided a Spoiler Alert Event for the same content, such as a sporting event (e.g., UCLA vs. Notre Dame). In determination block 511, the processor of a content presenting device may determine whether a majority of the computing devices have provided the Spoiler Alert Event for the given sporting event (or other program). In response to determining that a majority of the computing devices have provided a Spoiler Alert Event for the given sporting event or program (i.e., determination block 511=“Yes”), the processor of a content presenting device may implement content blocking based on the majority in block 513. In response to determining that a majority of the computing devices have not provided a Spoiler Alert Event for the same sporting event or program (i.e., determination block 511=“No”), or after performing the operations of block 513, the processor of a content presenting device may return to determination block 418 of the method 400 described with reference to FIG. 4A in block 507, where, subject to the application of other rules, the content may be presented unblocked in some embodiments.

In block 501 of the method 5005 illustrated in FIG. 5C, a processor of a content presenting device may proceed from applying rules in block 416 of the method 400 described above with reference to FIG. 4A. In block 515, the processor of a content presenting device may apply weights, such as weights based on priority (or other factor), for each device. Priority weights may be determined on a variety of factors such as company rank for mobile computing devices in a workplace environment. In such an example employees or officers of higher rank will have a higher weight associated with their Spoiler Alert Event information. In some embodiments, information about the rank of users may be transmitted with the Spoiler Alert Event information. Other priority weights may be possible, such as assigning a greater weight for the mobile computing device and thus Spoiler Alert Events registered to a user who has been in proximity to the content presenting device for the longest amount of time. In block 517, the processor of a content presenting device may apply content blocking and/or spoiler alerts based on the determined weights. In block 507, the processor of a content presenting device may return to determination block 418 of the method 400 described with reference to FIG. 4A.

In block 501 of the method 5007 illustrated in FIG. 5D, a processor of a content presenting device may proceed from applying rules in block 416 of the method 400 described above with reference to FIG. 4A. In block 519, the processor of a content presenting device may determine a date from which a Spoiler Alert Event has been active. For example, a user's content recording device may have recorded an event a month prior and the user has still not consumed the content. The information regarding the recording date of the content may be conveyed to the content presenting device by the user's mobile computing device. In determination block 521, the processor of a content presenting device may determine whether the date for the Spoiler Alert Event exceeds a threshold date. For example, the processor of a content presenting device may set the threshold at two weeks meaning any Spoiler Alert Events that are older than two weeks will not be honored. In response to determining that the date of the Spoiler Alert Event is within the threshold date (i.e., determination block 521=“Yes”), the processor of a content presenting device may apply content blocking in block 523 subject to the application of other rules such as voting rules, priority rules, and so on. In some example, when a mobile computing device is associated with a high priority, the processor of a content presenting device may apply a longer threshold date. In other embodiments (not shown), the Spoiler Alert Event information may include a release time (i.e., a time when the spoiler alert should be cancelled). In response to determining that the date of the Spoiler Alert Event is not within the threshold date (i.e., determination block 521=“No”), or after applying content blocking in block 523, the processor of a content presenting device may return to determination block 418 of the method 400 described with reference to FIG. 4A in block 509.

In block 501 of the method 5009 illustrated in FIG. 5E of a content presenting device may proceed from applying rules in block 416 of the method 400 described above with reference to FIG. 4A. In block 525, the processor of a content presenting device may determine the type of content being presented by the content presenting device. For example, the processor may determine that the content presenting device is presenting a particular content type, such as news, advertising, program content (e.g., television series, movie, etc.), sporting event content, and so on. In block 527, the processor of a content presenting device may refrain from applying content blocking based on the determined content type. For example, the processor of a content presenting device may not apply content blocking based on the content presenting device presenting news content. Alternatively, the processor of the content presenting device may provide a spoiler alert message in lieu of content blocking based on the type of content being presented. In block 507, the processor of a content presenting device may return to determination block 418 of the method 400 described with reference to FIG. 4A.

In block 501 of the method 5011 illustrated in FIG. 5F, a processor of a content presenting device may proceed from applying rules in block 416 of the method 400 described above with reference to FIG. 4A. In block 529, the processor of a content presenting device may establish a maximum content blocking time and advertise this blocking time to viewers. For example, the processor of a content presenting device may display the blocking time on the content presenting device or may send an alert message to the computing devices that indicates what the maximum blocking time is. Alternatively or additionally, the processor of a content presenting device may keep a running display of the remaining blocking time or send alter messages indicating the remaining blocking time. In block 531, the processor of a content presenting device may block content based on the maximum blocking time. For example, the processor of a content presenting device may apply blocking at the beginning of the blocking period and may remove blocking after the maximum blocking time expires. In block 507, the processor of a content presenting device may return to determination block 418 of the method 400 described with reference to FIG. 4A.

In block 501 of the method 5013 illustrated in FIG. 5G, a processor of a content presenting device may proceed from applying rules in block 416 of the method 400 described above with reference to FIG. 4A. In block 533, the processor of a content presenting device may determine Spoiler Alert Events among the various discovered devices. In determination block 535 the processor of a content presenting device may determine whether a spoiler alert service subscription fee has been paid. For example, the processor may determine through a transaction with the device that the user has paid a subscription for the content blocking and spoiler alert service. As another example, the processor of the content presenting device may determine through messages exchanged with the device that the user of the device has made a designated payment through other means. In some embodiments, the processor of the content presenting device may consult a server to determine whether a subscription payment has been made. In response to determining that a subscription fee has been paid (i.e., determination block 535=“Yes”), the processor of a content presenting device may apply content blocking in block 537. In response to determining that a subscription fee has not been paid (i.e., determination block 535=“No”), or when content blocking has been applied in block 537, the processor of a content presenting device may return to determination block 418 of the method 400 described with reference to FIG. 4A in block 507.

In block 501 of the method 5015 illustrated in FIG. 5H, a processor of a content presenting device may proceed from applying rules in block 416 of the method 400 described above with reference to FIG. 4A. In block 539, the processor of a content presenting device may select any one or a combination of rules illustrated in the methods described herein with reference to FIG. 5A through FIG. 5G, FIG. 5I and FIG. 5J to be applied in the embodiment method 400 as described with reference to FIG. 4A and FIG. 4B. In block 507, the processor of a content presenting device may return to determination block 418 of the method 400 described above with reference to FIG. 4A.

In block 501 of the method 5017 illustrated in FIG. 5I, a processor of a content presenting device may proceed from applying rules in block 416 of FIG. 4A. In determination block 541, the processor of a content presenting device may determine whether any of the rules or other conditions results in content blocking being prevented. Alternatively or additionally, in some embodiments, the processor of a content presenting device may apply a rule that enables the presentation of the spoiler content despite the application of other rules that otherwise restrict the presentation of the spoiler content. In response to determining that rules or conditions prevent content from being blocked (i.e., determination block 541=“Yes”), the processor of a content presenting device may provide a spoiler alert message in block 542. For example, when the presentation of the spoiler content is enabled despite being otherwise restricted by one or more other rules, a spoiler alert indication is provided that indicates to the given mobile computing device (or devices) that the presentation of the spoiler content will be enabled. Such an indication may be useful to allow devices that had previously registered spoiler alert events to leave the area of the content presentation device, or take other action to avoid viewing or hearing the spoiler content. A spoiler alert message may be sent by the processor of a content presenting device to the discovered devices to provide information that the content presenting device will not be blocking content and to advise the user of the device to avoid the area, to avoid watching or listening to the programming being presented by the content presenting device or other information. For example, the processor of a content presenting device may indicate when blocking will be resumed. The processor of a content presenting device may return to determination block 418 of the method 400 described with reference to FIG. 4A in block 507.

In some embodiments, users of mobile computing devices may be in a situation in which recorded content that is subject to the Spoiler Alert Event registration may be unlocked, such as through operation of a processor of a content presenting device. The processor may be operating in connection with the networking framework and may accept a mobile payment provided by the mobile computing devices. In an example, when a sufficient number of people in the vicinity of a public content presenting device, such as sitting in cafes, bars, and so on are interested in viewing content that they had previously recorded, content which is the subject of the Spoiler Alert Events may be presented. For example, a large marquis or display, or mobile televisions that may drive by or park, may present the recorded content that is the subject of the Spoiler Alert Events provided that a sufficient number of users agree to pay. In some examples, recorded content may displace currently displayed content provided enough mobile computing devices are present that have previously registered Spoiler Alert Events for the same content. Such displacement of displayed content may be based on feedback from mobile computing device users. For example, a sufficient number of users may not be satisfied with the currently displayed content of a content presenting device, which may be determined based on voting or other user inputs. A sufficient number of those same users may also have registered Spoiler Alert Events for the same content. In such a case, the content presenting device may terminate the current content and display the recorded content associated with the Spoiler Alert Events.

In block 501 of the method 5019 illustrated in FIG. 5J, a processor of a content presenting device may proceed from applying rules in block 416 of method 400 described above with reference to FIG. 4A. In block 543, the processor of a content presenting device may obtain a count of the number of Spoiler Alert Events that have been registered by different mobile computing devices for the same content (e.g., a sports event). In determination block 545, the processor may determine whether the number of registered Spoiler Alert Events for the same content is sufficient to meet or exceed a criteria, such as a majority of all the discovered mobile computing devices, or a threshold number of all the discovered mobile computing devices. In response to determining that an insufficient number of Spoiler Alert Events are registered for the same content (i.e., determination block 545=“No”), the processor of a content presenting device may return to determination block 418 of FIG. 4A in block 507 for further processing.

In response to determining that a sufficient number of Spoiler Alert Events are registered for the same content (i.e., determination block 545=“Yes”), the processor of the content presenting device may query the mobile computing devices that have registered Spoiler Alert Events for the same content to determine the number of such devices that are interested in an offer to view the recorded content in block 547. In some embodiments, the offer may be extended to devices that have not registered Spoiler Alert Events for the recorded content. The offer may be an offer to present the recorded content for a fee. In some embodiments, such as zone-based embodiments, the processor of the content presenting device may base the fee on a distance zone from the content presenting device as previously described. The fee for presenting the recorded content may be based on the zone since the separation distance may affect the user's ability to see and hear the content. For example, mobile computing devices in Zone 1 may pay a higher fee because they are close to the content presenting device and the mobile computing devices in Zones 2, 3 and beyond may pay a progressively lesser fee based on their distance from the content presenting device.

In determination block 549, the processor of a content presenting device may determine whether a sufficient number of the mobile computing devices have accepted the offer to present the recorded content, which may include payment of the fee or agreement to pay the fee (e.g., accept an offer to be billed for the presentation of the recorded content). For example, the processor of the content presenting device may receive transmitted messages from ones of the mobile computing devices that are registered with the networking framework. The messages from the mobile computing devices may be messages accepting the offer to present the recorded content. The messages may also contain confirmation of payment. In some embodiments, the users of the mobile computing devices may be billed or invoiced for their acceptance of the offer to receive the presented content. As discussed above, some users who have not registered Spoiler Alert Events may nevertheless receive and accept the offer to view the presented content. The processor may determine the sufficiency of accepters of the offer based on a metric, such as that a majority or super majority of the mobile computing devices that had registered a Spoiler Alert Event for the given content accepted the offer to view the recorded content based on the offer. In other embodiments, the processor may base the sufficiency of the accepters on an overall count of device accepting the offer regardless of whether or not they have registered Spoiler Alert Events for the given content. In response to determining that an insufficient number of the mobile computing devices have accepted the offer (e.g., transmitted a message or executed an electronic payment transaction) to present the recorded content, (i.e., determination block 549=“No”), the processor of the content presenting device may return to determination block 418 of the method 400 (FIG. 4A) in block 507.

In response to determining that a sufficient number of the mobile computing device have accepted the offer (e.g., transmitted a message and/or executed an electronic payment transaction) to present the recorded content, (i.e., determination block 549=“Yes”), the processor of a content presenting device may present the recorded content in block 551. In block 553, the processor of the content presenting device may optionally have previously provided the offer and may present the content based on the location zones of the mobile computing devices. For example, the processor of the content presenting device may charge the mobile computing devices that are closest to the content presenting device a relatively higher price than those devices that are farther away from the content presenting device, such as in a remotely located zone. In the event that the mobile computing devices in the outer zones do not accept the offer to view the recorded content, the processor may nevertheless present the recorded content, but may restrict the volume and other presentation parameters to limit the ability of users of the mobile computing devices in these zones to see or hear the content.

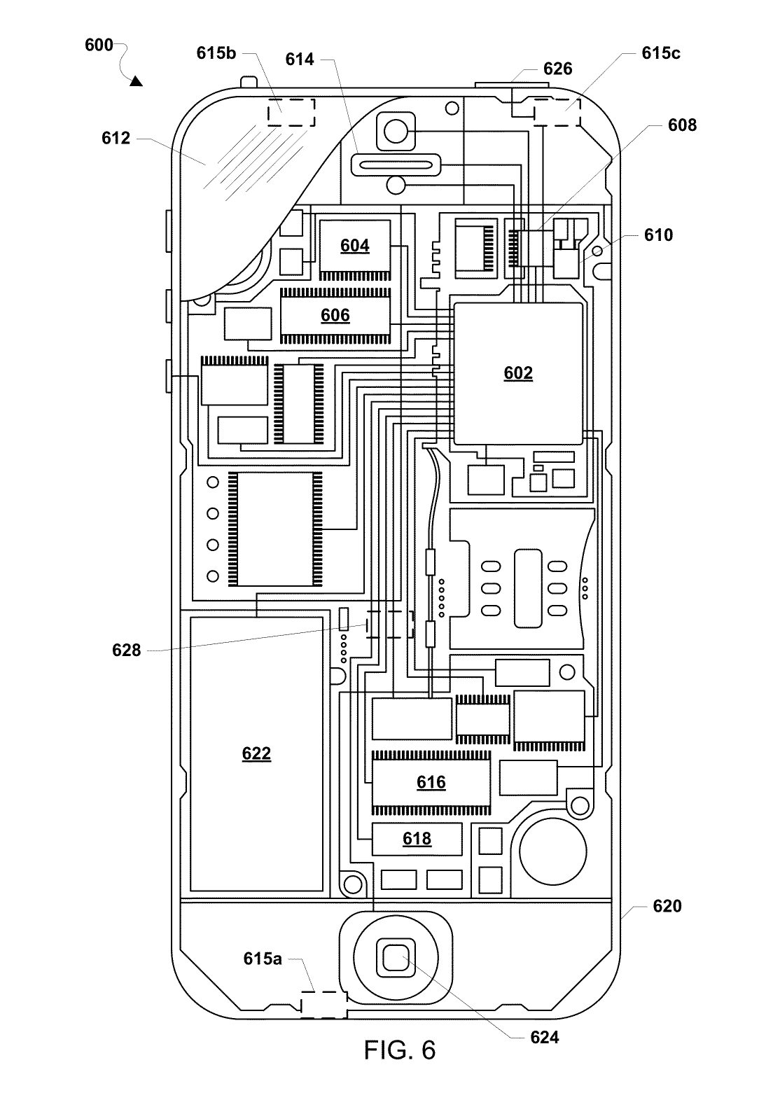

The various aspects may be implemented in any of a variety of mobile computing devices (e.g., smartphones, tablets, etc.) an example of which is illustrated in FIG. 6. The mobile computing device 600 may include a processor 602 coupled the various systems of the mobile computing device 600 for communication with and control thereof. For example, the processor 602 may be coupled to a touch screen controller 604, radio communication elements, speakers and microphones, and an internal memory 606. The processor 602 may be one or more multi-core integrated circuits designated for general or specific processing tasks. The internal memory 606 may be volatile or non-volatile memory, and may also be secure and/or encrypted memory, or unsecure and/or unencrypted memory, or any combination thereof. In another embodiment (not shown), the mobile computing device 600 may also be coupled to an external memory, such as an external hard drive.

The touch screen controller 604 and the processor 602 may also be coupled to a touch screen panel 612, such as a resistive-sensing touch screen, capacitive-sensing touch screen, infrared sensing touch screen, etc. Additionally, the display of the mobile computing device 600 need not have touch screen capability. The mobile computing device 600 may have one or more radio signal transceivers 608 (e.g., Peanut, Bluetooth, Bluetooth LE, Zigbee, Wi-Fi, RF radio, etc.) and antennae 610, for sending and receiving communications, coupled to each other and/or to the processor 602. The transceivers 608 and antennae 610 may be used with the above-mentioned circuitry to implement the various wireless transmission protocol stacks and interfaces. The mobile computing device 600 may include a cellular network wireless modem chip 616 that enables communication via a cellular network and is coupled to the processor.

The mobile computing device 600 may include a peripheral device connection interface 618 coupled to the processor 602. The peripheral device connection interface 618 may be singularly configured to accept one type of connection, or may be configured to accept various types of physical and communication connections, common or proprietary, such as USB, FireWire, Thunderbolt, or PCIe. The peripheral device connection interface 618 may also be coupled to a similarly configured peripheral device connection port (not shown).

In some embodiments, the mobile computing device 600 may include microphones 615. For example, the mobile computing device may have a conventional microphone 615a for receiving voice or other audio frequency energy from a user during a call. The mobile computing device 600 may further be configured with additional microphones 615b and 615c, which may be configured to receive audio including ultrasound signals. Alternatively, all microphones 615a, 615b, and 615c may be configured to receive ultrasound signals. The microphones 615 may be piezo-electric transducers, or other conventional microphone elements. Because more than one microphone 615 may be used, relative location information may be received in connection with a received ultrasound signal through various triangulation methods. At least two microphones 615 configured to receive ultrasound signals may be used to generate position information for an emitter of ultrasound energy.

The mobile computing device 600 may also include speakers 614 for providing audio outputs. The mobile computing device 600 may also include a housing 620, constructed of a plastic, metal, or a combination of materials, for containing all or some of the components discussed herein. The mobile computing device 600 may include a power source 622 coupled to the processor 602, such as a disposable or rechargeable battery. The rechargeable battery may also be coupled to the peripheral device connection port to receive a charging current from a source external to the mobile computing device 600. The mobile computing device 600 may also include a physical button 624 for receiving user inputs. The mobile computing device 600 may also include a power button 626 for turning the mobile computing device 600 on and off.

In some embodiments, the mobile computing device 600 may further include an accelerometer 628, which senses movement, vibration, and other aspects of the device through the ability to detect multi-directional values of and changes in acceleration. In the various embodiments, the accelerometer 628 may be used to determine the x, y, and z positions of the mobile computing device 600. Using the information from the accelerometer, a pointing direction of the mobile computing device 600 may be detected.

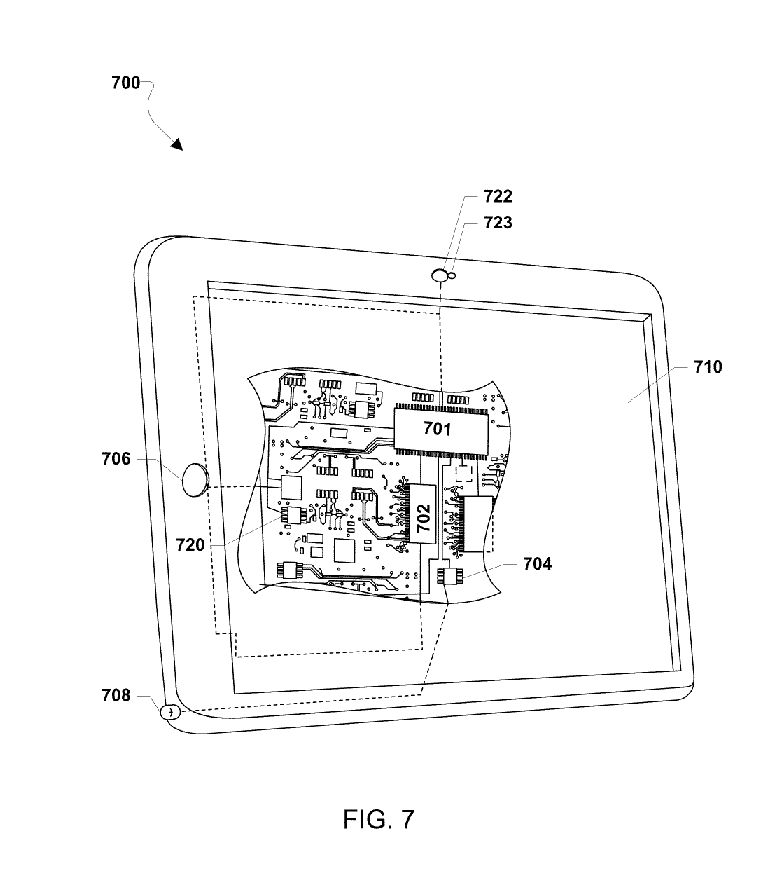

The various embodiments may be implemented in any of a variety of content presenting devices, example of which in the form of a flat screen television is illustrated in FIG. 7. For example, a flat screen television 700 may include a processor 701 coupled to internal memory 702. The internal memory 702 may be volatile or non-volatile memory, and may also be secure and/or encrypted memory, or unsecure and/or unencrypted memory, or any combination thereof. The processor 701 may also be coupled to a touch screen display 710, such as a resistive-sensing touch screen, capacitive-sensing touch screen infrared sensing touch screen, etc. The flat screen television 700 may have one or more radio signal transceivers 704 (e.g., Peanut, Bluetooth, Zigbee, WiFi, RF radio) and antennas 708 for sending and receiving wireless signals as described herein. The transceivers 704 and antennas 708 may be used with the above-mentioned circuitry to implement the various wireless transmission protocol stacks and interfaces. The flat screen television 700 may include a cellular network wireless modem chip 720 that enables communication via a cellular network. The flat screen television 700 may also include a physical button 706 for receiving user inputs. The flat screen television 700 may also include various sensors coupled to the processor 701, such as a camera 722, and a microphone or microphones 723.

For example, the flat screen television 700 may have a conventional microphone 723 for receiving voice commands or measuring ambient sound levels. The microphone 723 may be a piezo-electric transducer, or other conventional microphone elements.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of receiver smart objects, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. In a communication networking framework having a content presenting device and a mobile computing device configured to communicate with each other, a method for blocking spoiler content from being presented by the content presenting device comprising:
receiving one or more spoiler alert events from the mobile computing device, wherein each of the one or more spoiler alert events comprises information associated with content that has not been viewed by a user of the mobile computing device;
comparing the information with content to be presented by the content presenting device;
determining whether the content to be presented by the content presenting device includes the spoiler content based on the comparison; and
restricting a presentation of the spoiler content in the content to be presented if the content to be presented includes the spoiler content.

2. The method of claim 1, further comprising:
determining whether the content associated with the one or more spoiler alert events has been viewed by the user of the mobile computing device; and
clearing the one or more spoiler alert events when the content has been viewed by the user of the mobile computing device based on the determination.

3. The method of claim 1, wherein receiving one or more spoiler alert events from the mobile computing device comprises:
discovering a presence of the mobile computing device using the communication networking framework;
receiving from the mobile computing device the one or more spoiler alert events and the information about the content that has not been viewed; and
storing the one or more spoiler alert events and the information about the content that has not been viewed in a storage location accessible to the content presenting device.

4. The method of claim 1, wherein:
the information associated with the content that has not been viewed comprises one or more of a name of the content, a broadcast time of the content, a blocking release time of the content, and one or more keywords associated with the content; and
comparing the information with content to be presented by the content presenting device comprises scanning the content to be presented for one or more of the name of the content, the broadcast time of the content, the blocking release time of the content, and the one or more keywords associated with the content.

5. The method of claim 1, wherein restricting the presentation of the spoiler content in the content to be presented if the content to be presented includes the spoiler content comprises restricting the presentation of the spoiler content based on one or more rules.

6. The method of claim 5, wherein the one or more rules comprise a rule restricting presentation of the spoiler content based on a location zone of the mobile computing device, wherein:
when the location zone comprises a first location zone closest to the content presenting device, a video portion and an audio portion of the spoiler content are fully restricted;
when the location zone comprises a second location zone farther from the content presenting device than the first location zone, the video portion and the audio portion of the spoiler content are partially restricted; and
when the location zone comprises a third location zone farther from the content presenting device than the first location zone and the second location zone, the video portion of the spoiler content is not restricted and the audio portion of the spoiler content is restricted.

7. The method of claim 5, wherein the one or more rules comprise one or more of:
a rule restricting a presentation of the spoiler content based on a majority count of mobile computing devices providing spoiler alert events for the same content compared to a total count of a plurality of mobile computing devices in proximity to the content presenting device;
a rule restricting a presentation of the spoiler content based on a relative weight of a first one of the one or more spoiler alert events for a first one of the plurality of mobile computing devices in proximity to the content presenting device compared to a relative weight of a second one of the one or more spoiler alert events for a second one of the plurality of mobile computing devices in proximity to the content presenting device;
a rule restricting a presentation of the spoiler content based on an age of the one or more spoiler alert events, wherein the presentation of the spoiler content is not restricted when the age of the one or more spoiler alert events is older than a threshold age;
a rule restricting a presentation of the spoiler content based on a content type of the content to be presented by the content presenting device;
a rule restricting a presentation of the spoiler content based on a maximum blocking time, wherein the presentation of the spoiler content is not restricted after the maximum blocking time expires;
a rule restricting a presentation of the spoiler content based on a paid subscription service, wherein the presentation of the spoiler content associated with one of the one or more spoiler alert events for a given mobile computing device is restricted when a subscription fee associated with the given mobile computing device has been paid;
a rule enabling a presentation of the spoiler content when the presentation of the spoiler content is otherwise restricted by one or more other rules, and providing a spoiler alert indication that indicates to the given mobile computing device that the presentation of the spoiler content will not be restricted; and
a rule that presents the content that has not been viewed based on determining whether a sufficient number of the plurality of mobile computing devices that have registered one of the one or more spoiler alert events for the same content are in proximity to the presenting device and when a sufficient number of the plurality of mobile computing devices are present, presenting an offer to be displayed on each of the plurality of mobile computing devices to present the content that has not been viewed, and presenting the content that has not been viewed when a sufficient number of the plurality of mobile computing devices accept the offer.

8. A content presenting device, comprising:
a transceiver; and
a processor coupled to the transceiver, wherein the processor and the transceiver are configured to communicate with other devices using a communication networking framework, the processor configured with processor executable instructions to perform operations comprising:
receiving one or more spoiler alert events from a mobile computing device, wherein each of the one or more spoiler alert events comprises information associated with spoiler content, wherein the spoiler content comprises content that has not yet been viewed by a user of the mobile computing device;
comparing the information with content to be presented by the content presenting device;
determining whether the content to be presented by the content presenting device includes the spoiler content based on the comparison; and
restricting a presentation of the spoiler content in the content to be presented if the content to be presented includes the spoiler content.

9. The content presenting device of claim 8, wherein the processor is configured with processor executable instructions to perform operations further comprising:
determining whether the content associated with the one or more spoiler alert events has been viewed by the user of the mobile computing device; and
clearing the one or more spoiler alert events when the content has been viewed by the user of the mobile computing device based on the determination.

10. The content presenting device of claim 8, wherein the processor is configured with processor executable instructions to perform operations such that receiving one or more spoiler alert events from the mobile computing device comprises:
discovering a presence of the mobile computing device using the communication networking framework;
receiving from the mobile computing device the one or more spoiler alert events and the information about the content that has not been viewed; and
storing the one or more spoiler alert events and the information about the content that has not been viewed in a storage location accessible to the content presenting device.

11. The content presenting device of claim 8, wherein:
the information associated with the content that has not been viewed comprises one or more of a name of the content, a broadcast time of the content; a blocking release time of the content; and one or more keywords associated with the content; and
the processor is configured with processor executable instructions to perform operations such that comparing the information with content to be presented by the content presenting device comprises scanning the content to be presented for one or more of the name of the content; the broadcast time of the content; the blocking release time of the content; and the one or more keywords associated with the content.

12. The content presenting device of claim 8, wherein the processor is configured with processor executable instructions to perform operations such that restricting the presentation of the spoiler content in the content to be presented if the content to be presented includes the spoiler content comprises restricting the presentation of the spoiler content based on one or more rules.

13. The content presenting device of claim 12, wherein the one or more rules comprise a rule restricting the presentation of the spoiler content based on a location zone of the mobile computing device, wherein:
when the location zone comprises a first location zone closest to the content presenting device, a video portion and an audio portion of the spoiler content are fully restricted;
when the location zone comprises a second location zone farther from the content presenting device than the first location zone, the video portion and the audio portion of the spoiler content are partially restricted; and
when the location zone comprises a third location zone farther from the content presenting device than the first location zone and the second location zone, the video portion of the spoiler content is not restricted and the audio portion of the spoiler content is restricted.

14. The content presenting device of claim 12, wherein the one or more rules comprise one or more of:
a rule restricting a presentation of the spoiler content based on a majority count of mobile computing devices providing spoiler alert events for the same content compared to a total count of a plurality of mobile computing devices in proximity to the content presenting device;
a rule restricting a presentation of the spoiler content based on a relative weight of a first one of the one or more spoiler alert events for a first mobile computing device in proximity to the content presenting device compared to a relative weight of a second one of the one or more spoiler alert events for a second mobile computing device in proximity to the content presenting device;
a rule restricting a presentation of the spoiler content based on an age of the one or more spoiler alert events, wherein the presentation of the spoiler content is not restricted when the age of the one or more spoiler alert events is older than a threshold age;
a rule restricting a presentation of the spoiler content based on a content type of the content to be presented by the content presenting device;
a rule restricting a presentation of the spoiler content based on a maximum blocking time, wherein the presentation of the spoiler content is not restricted after the maximum blocking time expires;
a rule restricting a presentation of the spoiler content based on a paid subscription service, wherein the presentation of the spoiler content associated with one of the one or more spoiler alert events for a given mobile computing device is restricted when a subscription fee associated with the given mobile computing device has been paid;
a rule enabling a presentation of the spoiler content when the presentation of the spoiler content is otherwise restricted by one or more other rules, and providing a spoiler alert indication that indicates to the given mobile computing device that the presentation of the spoiler content will not be restricted; and
a rule that presents the content that has not been viewed based on determining whether a sufficient number of the plurality of mobile computing devices that have registered one of the one or more spoiler alert events for the same content are in proximity to the presenting device and when a sufficient number of the plurality of mobile computing devices are present, presenting an offer to be displayed on each of the plurality of mobile computing devices to present the content that has not been viewed, and presenting the content that has not been viewed when a sufficient number of the plurality of mobile computing devices accept the offer.

15. A content presenting device configured to block spoiler content from being presented to a user of a mobile computing device in proximity to the content presenting device, the content presenting device and the mobile computing device configured to communicate with each other using a communication networking framework, the content presenting device comprising:
means for receiving one or more spoiler alert events from the mobile computing device, wherein each of the one or more spoiler alert events comprises information associated with content that has not been viewed by the user of the mobile computing device;
means for comparing the information with content to be presented by the content presenting device;
means for determining whether the content to be presented by the content presenting device includes the spoiler content based on the comparison; and
means for restricting a presentation of the spoiler content in the content to be presented if the content to be presented includes the spoiler content.

16. The content presenting device of claim 15, further comprising:
means for determining whether the content associated with the one or more spoiler alert events has been viewed by the user of the mobile computing device; and
means for clearing the one or more spoiler alert events when the content has been viewed by the user of the mobile computing device based on the determination.

17. The content presenting device of claim 15, wherein means for receiving one or more spoiler alert events from the mobile computing device comprises:
means for discovering a presence of the mobile computing device using the communication networking framework;
means for receiving from the mobile computing device the one or more spoiler alert events and the information about the content that has not been viewed; and
means for storing the one or more spoiler alert events and the information about the content that has not been viewed in a storage location accessible to the content presenting device.

18. The content presenting device of claim 15, wherein:
the information associated with the content that has not been viewed comprises one or more of a name of the content, a broadcast time of the content; a blocking release time of the content; and one or more keywords associated with the content; and
means for comparing the information with content to be presented by the content presenting device comprises means for scanning the content to be presented for one or more of the name of the content; the broadcast time of the content; the blocking release time of the content; and the one or more keywords associated with the content.

19. The content presenting device of claim 15, wherein means for restricting the presentation of the spoiler content in the content to be presented if the content to be presented includes the spoiler content comprises means for restricting the presentation of the spoiler content based on one or more rules.

20. The content presenting device of claim 19, wherein the one or more rules comprise a rule restricting the presentation of the spoiler content based on a location zone of the mobile computing device, wherein:
when the location zone comprises a first location zone closest to the content presenting device, a video portion and an audio portion of the spoiler content are fully restricted;
when the location zone comprises a second location zone farther from the content presenting device than the first location zone, the video portion and the audio portion of the spoiler content are partially restricted; and
when the location zone comprises a third location zone farther from the content presenting device than the first location zone and the second location zone, the video portion of the spoiler content is not restricted and the audio portion of the spoiler content is restricted.

21. The content presenting device of claim 19, wherein the one or more rules comprise one or more of:
a rule restricting a presentation of the spoiler content based on a majority count of mobile computing devices providing spoiler alert events for the same content compared to a total count of a plurality of mobile computing devices in proximity to the content presenting device;
a rule restricting a presentation of the spoiler content based on a relative weight of a first one of the one or more spoiler alert events for a first mobile computing device in proximity to the content presenting device compared to a relative weight of a second one of the one or more spoiler alert events for a second mobile computing device in proximity to the content presenting device;
a rule restricting a presentation of the spoiler content based on an age of the one or more spoiler alert events, wherein the presentation of the spoiler content is not restricted when the age of the one or more spoiler alert events is older than a threshold age;
a rule restricting a presentation of the spoiler content based on a content type of the content to be presented by the content presenting device;
a rule restricting a presentation of the spoiler content based on a maximum blocking time, wherein the presentation of the spoiler content is not restricted after the maximum blocking time expires;
a rule restricting a presentation of the spoiler content based on a paid subscription service, wherein the presentation of the spoiler content associated with one of the one or more spoiler alert events for a given mobile computing device is restricted when a subscription fee associated with the given mobile computing device has been paid;
a rule enabling a presentation of the spoiler content when the presentation of the spoiler content is otherwise restricted by one or more other rules, and providing a spoiler alert indication that indicates to the given mobile computing device that the presentation of the spoiler content will not be restricted; and
a rule that presents the content that has not been viewed based on determining whether a sufficient number of the plurality of mobile computing devices that have registered one of the one or more spoiler alert events for the same content are in proximity to the presenting device and when a sufficient number of the plurality of mobile computing devices are present, presenting an offer to be displayed on each of the plurality of mobile computing devices to present the content that has not been viewed, and presenting the content that has not been viewed when a sufficient number of the plurality of mobile computing devices accept the offer.

22. A non-transitory processor-readable storage medium having stored thereon processor-executable instructions configured to cause a processor of a content presenting device to perform operations comprising:
receiving one or more spoiler alert events from a mobile computing device using a communication networking framework, wherein each of the one or more spoiler alert events comprises information associated with spoiler content, wherein the spoiler content comprises content that has not yet been viewed by a user of the mobile computing device;
comparing the information with content to be presented by the content presenting device;
determining whether the content to be presented by the content presenting device includes the spoiler content based on the comparison; and
restricting a presentation of the spoiler content in the content to be presented if the content to be presented includes the spoiler content.

23. The non-transitory processor-readable storage medium of claim 22, wherein the processor-executable instructions are configured to cause the processor of the content presenting device to perform operations further comprising:
determining whether the content associated with the one or more spoiler alert events has been viewed by the user of the mobile computing device; and
clearing the one or more spoiler alert events when the content has been viewed by the user of the mobile computing device based on the determination.

24. The non-transitory processor-readable storage medium of claim 22, wherein the processor-executable instructions are configured to cause the processor of the content presenting device to perform operations such that receiving one or more spoiler alert events from the mobile computing device using the communication networking framework comprises:
discovering a presence of the mobile computing device using the communication networking framework;
receiving from the mobile computing device the one or more spoiler alert events and the information about the content that has not been viewed using the communication networking framework; and
storing the one or more spoiler alert events and the information about the content that has not been viewed in a storage location accessible to the content presenting device using the communication networking framework.

25. The non-transitory processor-readable storage medium of claim 22, wherein:
the information associated with the content that has not been viewed comprises one or more of a name of the content, a broadcast time of the content; a blocking release time of the content; and one or more keywords associated with the content; and
the processor-executable instructions are configured to cause the processor of the content presenting device to perform operations such that comparing the information with content to be presented by the content presenting device comprises scanning the content to be presented for one or more of the name of the content; the broadcast time of the content; the blocking release time of the content; and the one or more keywords associated with the content.

26. The non-transitory processor-readable storage medium of claim 22, wherein the processor-executable instructions are configured to cause the processor of the content presenting device to perform operations such that restricting the presentation of the spoiler content in the content to be presented by the content presenting device based on determining that the content to be presented includes the spoiler content comprises restricting the presentation of the spoiler content based on one or more rules.

27. The non-transitory processor-readable storage medium of claim 26, wherein the one or more rules comprise a rule restricting the presentation of the spoiler content based on a location zone of the mobile computing device, wherein:
when the location zone comprises a first location zone closest to the content presenting device, a video portion and an audio portion of the spoiler content are fully restricted;
when the location zone comprises a second location zone farther from the content presenting device than the first location zone, the video portion and the audio portion of the spoiler content are partially restricted; and
when the location zone comprises a third location zone farther from the content presenting device than the first location zone and the second location zone, the video portion of the spoiler content is not restricted and the audio portion of the spoiler content is restricted.

28. The non-transitory processor-readable storage medium of claim 26, wherein the one or more rules comprise one or more of:
a rule restricting a presentation of the spoiler content based on a majority count of mobile computing devices providing spoiler alert events for the same content compared to a total count of a plurality of mobile computing devices in proximity to the content presenting device;
a rule restricting a presentation of the spoiler content based on a relative weight of a first one of the one or more spoiler alert events for a first mobile computing device in proximity to the content presenting device compared to a relative weight of a second one of the one or more spoiler alert events for a second mobile computing device in proximity to the content presenting device;
a rule restricting a presentation of the spoiler content based on an age of the one or more spoiler alert events, wherein the presentation of the spoiler content is not restricted when the age of the one or more spoiler alert events is older than a threshold age;
a rule restricting a presentation of the spoiler content based on a content type of the content to be presented by the content presenting device;
a rule restricting a presentation of the spoiler content based on a maximum blocking time, wherein the presentation of the spoiler content is not restricted after the maximum blocking time expires;
a rule restricting a presentation of the spoiler content based on a paid subscription service, wherein the presentation of the spoiler content associated with one of the one or more spoiler alert events for a given mobile computing device is restricted when a subscription fee associated with the given mobile computing device has been paid;
a rule enabling a presentation of the spoiler content when the presentation of the spoiler content is otherwise restricted by one or more other rules, and providing a spoiler alert indication that indicates to the given mobile computing device that the presentation of the spoiler content will not be restricted; and
a rule that presents the content that has not been viewed based on determining whether a sufficient number of the plurality of mobile computing devices that have registered one of the one or more spoiler alert events for the same content are in proximity to the presenting device and when a sufficient number of the plurality of mobile computing devices are present, presenting an offer to be displayed on each of the plurality of mobile computing devices to present the content that has not been viewed, and presenting the content that has not been viewed when a sufficient number of the plurality of mobile computing devices accept the offer.
